(19) United States
(12) Patent Application Publication
(10) Pub. No.: US 2011/0274932 A1
(43) Pub. Date: Nov. 10, 2011

(54) COMPONENT COMPRISING AN INSERT PART AND PLASTICS JACKETING, AND PROCESS FOR PRODUCTION OF THE COMPONENT

(75) Inventors: Rebekka von Benten, Ludwigshafen (DE); Alireza Talebloo, Mainz (DE); Harald Kröger, Bohl-Iggelheim (DE); Peter Eibeck, Speyer (DE)

(73) Assignee: BASF SE, Ludwigshafen (DE)

(21) Appl. No.: 13/101,543

(22) Filed: May 5, 2011

Related U.S. Application Data
(60) Provisional application No. 61/331,399, filed on May 5, 2010.

(51) Int. Cl. B32B 27/38; B29C 45/14; B32B 27/36

(52) U.S. Cl. 428/412; 428/414; 428/416; 264/255

(57) ABSTRACT

The invention relates to a component comprising an insert part and plastics jacketing composed of at least two plastics components, where the insert part is enclosed by a first plastics component A1 or by a first plastics component A2, and the first plastics component A1 or the first plastics component A2 is enclosed by a second plastics component B, where the second plastics component B is composed of
B1: 10 to 99.99% by weight of at least one thermoplastic polyester,
B2: 0.01 to 50% by weight of
   B21: at least one highly branched or hyperbranched polycarbonate having an OH number of 1 to 600 mg KOH/g polycarbonate (as per DIN 53249, Part 2)
   or
   B22: at least one highly branched or hyperbranched polyester of the type AₓB_{y}, where x is at least one 1.1 and y is at least 2.1,
or mixtures thereof.

The invention relates to a component comprising an insert part and plastics jacketing composed of at least two plastics components, where the insert part is enclosed by a plastics component A and there is a second plastics component B enclosing the first plastics component A. The invention further relates to a process for the production of this component.

Components which comprise an insert part and plastics jacketing are used by way of example when metallic insert parts are used for the integration of electronics components, e.g. in automobile technology or in aerospace technology. A leakproof or coherent bond is required in the component here, in order to prevent ingress of moisture or liquid and resultant damage to the electronic components. The component has to remain leakproof even when it is subject to temperature variations. One reason for defective leakproof properties in the coherent bond in composite structures composed of a metallic insert part with plastics jacketing can derive for example from poor wetting of the metal component by the plastics component, resulting in poor adhesion. Differences in the thermal expansion of the metallic component and of the plastics component also lead to stresses which can cause cracks.

A component in the form of a plug in which plastics jacketing encloses a metallic insert part is known by way of example from EP-B 0 249 975. In order to achieve a leakproof bond between plastic and metal, there is a flexible plastics material introduced between the exterior plastics material and the metallic insert part. The flexible plastics material is, for example, an unreinforced thermoplastic elastomer.

EP-A 1 496 587 discloses a composite component in which a flat cable is passed out from a sealed structure composed of a plastics material. In order to seal the gap where the cable emerges from the plastics material, the aperture is filled by a liquid rubber, which is then cured.

DE-C 100 53 115 also describes a passageway for a cable composed of a plastics jacket. The sealing here is achieved via a sealant which has adhesive properties both with respect to the material of the bushing and with respect to the jacket material of the lines. Examples mentioned of suitable sealants are fat, wax, resin, bitumen, or the like.

Another plug connector in which a solid jacket composed of a plastics material receives metallic pins is also known from EP-A 0 245 975. A flexible plastics material is used between the metal pins and the exterior jacket, in order to achieve a leakproof bond.

WO-A 2008/099009 also discloses a component in which a plastics layer jackets an insert part. The metallic insert part in said component is first sheathed by a low-viscosity plastics composition, and, in a second step, a hard plastics component is injected around the sheathing. Suitable plastics mentioned which have the low viscosity are polyamides, aliphatic polyesters, or polyesters based on aliphatic and aromatic dicarboxylic acids and on aliphatic dihydroxy compounds.

DE-B 10 2005 033 912 also discloses another casing passageway in which an electrical contact is conducted through a casing, and in which the casing passageway has been sealed in such a way as to prevent ingress of undesired substances. In order to achieve sealing, a galvanizing process is used to increase the roughness depth of the conductor element in the region of sealing.

A disadvantage of plastics jacketing of insert parts throughout the prior art is that it does not provide adequate leakproof properties, in particular when it is used under conditions of temperature change.

It is therefore an object of the present invention to provide a component which comprises an insert part and plastics jacketing, and in which the plastics jacketing provides adequate leakproof properties even during storage under conditions of temperature change.

The object is achieved by a component comprising an insert part and plastics jacketing composed of at least two plastics components, where the insert part is enclosed by a first plastics component A1, where the first plastics component A1 is composed of:
A11: from 5 to 80% by weight, based on the total weight of components A11 and A12, of at least one polyester based on aliphatic and aromatic dicarboxylic acids and on aliphatic dihydroxy compounds;
A12: 20 to 95% by weight, based on the total weight of components A11 and A12, of at least one homo- or copolyester selected from the group consisting of polylactide (PLA), polycaprolactone, polyhydroxyalkanoates, and polyester derived from aliphatic dicarboxylic acids and aliphatic diols;
A13: 0.05 to 15% by weight, based on the total weight of components A11 and A12, a) of a copolymer which contains epoxy groups and which is based on styrene, on acrylate, and/or on methacrylate, b) of a bisphenol A epoxide, or c) of a fatty acid amide, fatty acid ester, or natural oil containing epoxy groups,

or by a first plastics component A2, the first plastics component A2 being composed of:
A21: 10 to 100% by weight, based on the total weight of components A21 and A22, of at least one thermoplastics styrene (co)polymer,
A22: 0 to 90% by weight, based on the total weight of components A21 and A22, of at least one thermoplastic (co)polyester,
A23: 0.05 to 15% by weight, based on the total weight of components A21 and A22, a) of a copolymer which contains epoxy groups and which is based on styrene on acrylate, and/or on methacrylate, b) of a bisphenol A epoxide, or c) of a fatty acid amide, fatty acid ester, or natural oil containing epoxy groups,

and the first plastics component A1 or the first plastics component A2 is enclosed by a second plastics component B, and the second plastics component B is composed of
B1: 10 to 99.99% by weight of at least one thermoplastic polyester,
B2: 0.01 to 50% by weight of
   B21: at least one highly branched or hyperbranched polycarbonate having an OH number of 1 to 600 mg KOH/g polycarbonate (as per DIN 53249, Part 2)
or
   B22: at least one highly branched or hyperbranched polyester of the type AₓB_{y} where x is at least 1.1 and y is at least 2.1,

or mixtures thereof,

it being further possible for the first plastics component A1 or the first plastics component A2 and/or the second plastics component B to comprise:
C 0 to 60% by weight of at least one further adjuvant.

The use of the inventive second plastics component B in combination with the first plastics component A1 or with the first plastics component A2, the first plastics component A1 being composed of the at least one polyester based on aliphatic and aromatic dicarboxylic acids and on aliphatic dihydroxy compounds, and also of the at least one homo- or copolyester selected from the group consisting of polylactide, polycaprolactone, polyhydroxyalkanoates, and polyesters derived from aliphatic dicarboxylic acids and aliphatic diols, and the first plastics component A2 is composed of the at least one thermoplastics styrene (co)polymer and if desired, of the at least one thermoplastic (co)polyester, achieves significantly improved leakproof properties when comparison is made with the plastics jacketings known from the prior art, in particular when the component is used under conditions of temperature change. A further improvement is achieved through the injection of the first plastics component A1 or A2 around in the interior, and by the injection of the second plastics component B around on the exterior.

An advantage of the use of component B is that, through the addition of the highly branched or hyperbranched polycarbonate and/or of the highly branched or hyperbranched polyester, said component exhibits improved adhesion to the first plastics component A1 or A2, thus giving the bond better leakproof properties. Also of advantage is a better fluidity and hence better processing properties. A further advantage is that the use of the highly branched or hyperbranched polycarbonates and/or polyesters does not result in a reduction in the mechanical properties when the amount of the additive is increased. Moreover, the structures of the highly branched or hyperbranched polycarbonates and/or highly branched or hyperbranched polyesters can easily be adapted to the requirements of the application in thermoplastics. Furthermore, on account of their defined construction, the highly branched or hyperbranched polycarbonates and/or highly branched or hyperbranched polyesters unite advantageous properties, such as high functionality, high reactivity, low viscosity, and good solubility.

First Plastics Component A1

In accordance with the invention the first plastics component A1 is composed of:
A11: from 5 to 80% by weight, based on the total weight of components A11 and A12, of at least one semiaromatic polyester based on aliphatic and aromatic dicarboxylic acids and on aliphatic dihydroxy compounds;
A12: 20 to 95% by weight, based on the total weight of components A11 and A12, of at least one homo- or copolyester selected from the group consisting of polylactide (PLA), polycaprolactone, polyhydroxyalkanoates, and polyester derived from aliphatic dicarboxylic acids and aliphatic diols;
A13: 0.05 to 15% by weight, based on the total weight of components A11 and A12, a) of a copolymer which contains epoxy groups and which is based on styrene, on acrylate, and/or on methacrylate, b) of a bisphenol A epoxide, or c) of a fatty acid amide, fatty acid ester, or natural oil containing epoxy groups.

Among the particularly preferred semiaromatic polyesters A11 are polyesters which comprise, as essential components,
1) an acid component composed of
1a) from 30 to 99 mol % of at least one aliphatic or at least one cycloaliphatic dicarboxylic acid, or ester-forming derivatives thereof, or a mixture thereof,
1b) from 1 to 70 mol % of at least one aromatic dicarboxylic acid, or ester-forming derivative thereof, or a mixture thereof, and
1c) from 0 to 5 mol % of a compound containing sulfonate groups,
2) a diol component selected from at least one C₂-C₁₂ alkanediol or from at least one C₅-C₁₀ cycloalkanediol, or a mixture thereof,

and, if desired, also comprising one or more components selected from
3) a component selected from
3a) at least one dihydroxy compound of the formula (I) comprising ether functions

HO—[(CH₂)ₙ—O]ₘ—H (I)

in which n is 2, 3, or 4, and m is an integer from 2 to 250,
3b) at least one hydroxycarboxylic acid of the formula (IIa) or (IIb)

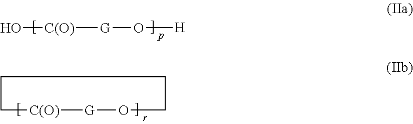

in which p is an integer from 1 to 1500 and r is an integer from 1 to 4, and G is a radical selected from the group consisting of phenylene, —(CH₂)_{q}—, where q is an integer from 1 to 5, —C(R)H— and —C(R)HCH₂, where R is methyl or ethyl,
3c) at least one amino-C₂-C₁₂ alkanol or at least one amino-C₅-C₁₀ cycloalkanol, or a mixture thereof,
3d) at least one diamino-C₁-C₈ alkane,
3e) at least one 2,2′-bisoxazoline of the general formula (III)

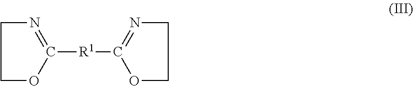

where R¹ is a single bond, a (CH₂)_{z}-alkylene group, where z=2, 3, or 4, or a phenylene group,
3f) at least one aminocarboxylic acid selected from the group consisting of the natural amino acids, polyamides obtainable via polycondensation of a dicarboxylic acid having from 4 to 6 C atoms and of a diamine having from 4 to 10 C atoms, compounds of the formulae (IVa) and (IVb)

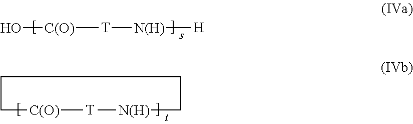

in which s is an integer from 1 to 1500 and t is an integer from 1 to 4, and T is a radical selected from the group consisting of phenylene, —(CH₂)ᵤ—, where u is an integer from 1 to 12, —C(R²)H— and —C(R²)HCH₂, where R² is methyl or ethyl,

and from polyoxazolines having the repeat unit V

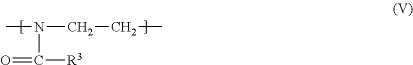

in which R³ is hydrogen, C₁-C₆-alkyl, C₅-C₈-cycloalkyl, phenyl which is unsubstituted or which has up to three substituents that are C₁-C₄-alkyl groups, or is tetrahydrofuryl,

or a mixture of 3a) to 3f),

and
4) a component selected from
4a) at least one compound having at least three groups capable of ester formation,
4b) at least one isocyanate,
4c) at least one divinyl ether,

or a mixture of 4a) to 4c).

In one preferred embodiment, the acid component 1) of the semiaromatic polyesters A11 comprises from 30 to 70 mol %, in particular from 40 to 60 mol %, of 1a) and from 30 to 70 mol %, in particular from 40 to 60 mol %, of 1b).

Aliphatic acids and the corresponding derivatives 1a) that can be used are generally those having from 2 to 10 carbon atoms, preferably from 4 to 6 carbon atoms. They can be linear or branched. The cycloaliphatic dicarboxylic acids that can be used for the purposes of the present invention are generally those having from 7 to 10 carbon atoms and in particular those having 8 carbon atoms. However, it is also possible in principle to use dicarboxylic acids having a larger number of carbon atoms, for example having up to 30 carbon atoms.

Examples that may be mentioned are: malonic acid, succinic acid, glutaric acid, 2-methylglutaric acid, 3-methylglutaric acid, adipic acid, pimelic acid, azeleic acid, sebacic acid, fumaric acid, 2,2-dimethylglutaric acid, suberic acid, 1,3-cyclopentanedicarboxylic acid, 1,4-cyclohexanedicarboxylic acid, 1,3-cyclohexanedicarboxylic acid, diglycolic acid, itaconic acid, maleic acid, and 2,5-norbomanedicarboxylic acid.

Particular mention may be made of the following ester-forming derivatives of the abovementioned aliphatic or cycloaliphatic dicarboxylic acids, which can likewise be used: the di-C₁-C₆-alkyl esters, such as dimethyl, diethyl, di-n-propyl, diisopropyl, di-n-butyl, diisobutyl, di-tert-butyl, di-n-pentyl, diisopentyl, or di-n-hexyl esters. It is likewise possible to use anhydrides of the dicarboxylic acids.

The dicarboxylic acids or ester-forming derivatives thereof can be used individually here or in the form of a mixture of two or more thereof.

It is preferable to use succinic acid, adipic acid, azelaic acid, sebacic acid, brassylic acid, or the respective ester-forming derivatives of these, or a mixture thereof. It is particularly preferable to use succinic acid, adipic acid, or sebacic acid, or the respective ester-forming derivatives of these, or a mixture thereof. It is particularly preferable to use adipic acid or ester-forming derivatives thereof, for example the alkyl esters thereof, or a mixture thereof. If polymer mixtures having “hard” or “brittle” components A12 are being produced, an example being polyhydroxybutyrate or in particular polylactide, the aliphatic dicarboxylic acid used preferably comprises sebacic acid or a mixture of sebacic acid with adipic acid. If polymer mixtures having “soft” or “tough” components A12 are being produced, an example being polyhydroxybutyrate-co-valerate, the aliphatic dicarboxylic acid used preferably comprises succinic acid or a mixture of succinic acid with adipic acid.

Another advantage of succinic acid, azelaic acid, sebacic acid, and brassylic acid is that they are accessible in the form of renewable raw materials.

Aromatic dicarboxylic acids 1b) that may be mentioned are generally those having from 8 to 12 carbon atoms and preferably those having 8 carbon atoms. Mention may be made by way of example of terephthalic acid, isophthalic acid, 2,6-naphthoic acid and 1,5-naphthoic acid, and also ester-forming derivatives thereof. Particular mention may be made here of the di-C₁-C₆-alkyl esters, e.g. dimethyl, diethyl, di-n-propyl, diisopropyl, di-n-butyl, diisobutyl, di-tert-butyl, di-n-pentyl, diisopentyl, or di-n-hexyl esters. The anhydrides of the dicarboxylic acids 1b) are equally suitable ester-forming derivatives.

However, it is also possible in principle to use aromatic dicarboxylic acids 1b) having a larger number of carbon atoms, for example up to 20 carbon atoms.

The aromatic dicarboxylic acids or ester-forming derivatives of these 1b) can be used individually or in the form of a mixture made of two or more thereof. It is particularly preferable to use terephthalic acid or ester-forming derivatives thereof, e.g. dimethyl terephthalate.

The compound used containing sulfonate groups usually comprises an alkali metal or an alkaline earth metal salt of a dicarboxylic acid containing sulfonate groups, or ester-forming derivatives thereof, preferably alkali metal salts of 5-sulfoisophthalic acid, or a mixture of these, particularly preferably the sodium salt.

According to one of the preferred embodiments, the acid component 1) comprises from 40 to 60 mol % of 1a), from 40 to 60 mol % of 1b), and from 0 to 2 mol % of 1c). According to another preferred embodiment, the acid component 1) comprises from 40 to 59.9 mol % of 1a), from 40 to 59.9 mol % of 1b), and from 0.1 to 1 mol % of 1c), in particular from 40 to 59.8 mol % of 1a), from 40 to 59.8 mol % of 1b), and from 0.2 to 0.5 mol % of 1c).

The diols 2) are generally selected among branched or linear alkanediols having from 2 to 12 carbon atoms, preferably from 4 to 6 carbon atoms, or among cycloalkanediois having from 5 to 10 carbon atoms.

Examples of suitable alkanediols are ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, in particular ethylene glycol, 1,3-propanediol, 1,4-butanediol, and 2,2-dimethyl-1,3-propanediol (neopentyl glycol); cyclopentanediol, 1,4-cyclohexanediol, 1,2-cyclohexanedimethanol, 1,3-cyclohexanedimethanol, 1,4-cyclohexanedimethanol, or 2,2,4,4-tetramethyl-1,3-cyclobutanediol. Particular preference is given to 1,4-butanediol, in particular in combination with adipic acid as component a1), and 1,3-propanediol, in particular in combination with sebacic acid as component a1). Another advantage of 1,3-propanediol and 1,4-butanediol is that they are accessible in the form of renewable raw materials. It is also possible to use a mixture of various alkanediols.

As a function of whether an excess of acid end groups or of OH end groups is desired, an excess can be used either of component A or of component B. According to one preferred embodiment, the molar ratio of components A and B used can be in the range from 0.4:1 to 1.5:1, preferably in the range from 0.6:1 to 1.1:1.

The polyesters on which the polyester mixtures of the invention are based can comprise further components, alongside components 1) and 2).

The dihydroxy compounds 3a) used preferably comprise diethylene glycol, triethylene glycol, polyethylene glycol, polypropylene glycol, and polytetrahydrofuran (polyTHF), particularly preferably diethylene glycol, triethylene glycol, and polyethylene glycol, and it is also possible here to use a mixture thereof, or to use compounds which have various variables n (see formula (I)), an example being polyethylene glycol, which comprises propylene units (n=3), obtainable by way of example via polymerization using methods known per se, first of ethylene oxide, and then using propylene oxide, particular preference being given to a polymer based on polyethylene glycol having various variables n, where units formed from ethylene oxide predominate. The molar mass (Mₙ) of the polyethylene glycol is generally selected within the range from 250 to 8000 g/mol, preferably from 600 to 3000 g/mol.

According to one preferred embodiment, it is possible to use by way of example from 15 to 98 mol %, preferably from 60 to 99.5 mol %, of the diols 2) and from 0.2 to 85 mol %, preferably from 0.5 to 30 mol %, of the dihydroxy compounds 3a), based on the molar amount of 2) and 3a), for producing the semiaromatic polyesters.

In one preferred embodiment, the hydroxycarboxylic acid 3b) used comprises: glycolic acid, D-, L-, or D,L-lactic acid, 6-hydroxyhexanoic acid, cyclic derivatives thereof, such as glycolide (1,4-dioxane-2,5-dione), D- or L-dilactide (3,6-dimethyl-1,4-dioxane-2,5-dione), p-hydroxybenzoic acid, and also oligomers thereof and polymers, such as 3-polyhydroxybutyric acid, polyhydroxyvaleric acid, polylactide (obtainable for example in the form of NatureWorks® (Cargill)), or else a mixture of 3-polyhydroxybutyric acid and polyhydroxyvaleric acid (the latter being obtainable as Biopol® from Zeneca), and it is particularly preferable to use the low-molecular-weight and cyclic derivatives thereof for producing semiaromatic polyesters.

Examples of amounts that can be used of the hydroxycarboxylic acids are from 0.01 to 50% by weight, preferably from 0.1 to 40% by weight, based on the amount of 1) and 2).

The amino-C₂-C₁₂ alkanol or amino-C₅-C₁₀ cycloalkanol (component 3c) used, where these include 4-aminomethylcyclohexanemethanol, preferably comprises amino-C₂-C₈ alkanols, such as 2-aminoethanol, 3-aminopropanol, 4-aminobutanol, 5-aminopentanol, 6-aminohexanol, or else amino-C₅-C₆ cycloalkanols, such as aminocyclopentanol and aminocyclohexanol, or a mixture thereof.

The diamino-C₁-C₆ alkane (component 3d) used preferably comprises diamino-C₄-C₆ alkanes, such as 1,4-diaminobutane, 1,5-diaminopentane, and 1,6-diaminohexane (hexamethylenediamine, “HMD”).

In one preferred embodiment, the materials used to produce the semiaromatic polyesters can comprise from 0.5 to 99.5 mol %, preferably from 0.5 to 50 mol %, of 3c), based on the molar amount of 2), and from 0 to 50 mol %, preferably from 0 to 35 mol %, of 3d), based on the molar amount of 2).

The 2,2′-bisoxazolines 3e) of the general formula (III) are generally obtainable via the process in Angew. Chem. Int. Edit., vol. 11 (1972), pp. 287-288. Particularly preferred bisoxazolines are those in which R¹ is a single bond, a (CH₂)_{z}-alkylene group, where z=2, 3, or 4, e.g. methylene, ethane-1,2-diyl, propane-1,3-diyl, propane-1,2-diyl, or a phenylene group. Particularly preferred bisoxazolines that may be mentioned are 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)benzene.

Production of the semiaromatic polyesters A11 can by way of example use from 70 to 98 mol % of 2), up to 30 mol % of 3c), and from 0.5 to 30 mol % of 3d), and from 0.5 to 30 mol % of 3e), in each case based on the total of the molar amounts of components 2), 3c), 3d), and 3e). In another preferred embodiment, it is possible to use from 0.1 to 5% by weight, preferably from 0.2 to 4% by weight, of 3e), based on the total weight of 1) and 2).

The component 3f) used can comprise natural aminocarboxylic acids. Among these are valine, leucine, isoleucine, threonine, methionine, phenylalanine, tryptophane, lysine, alanine, arginine, aspartamic acid, cysteine, glutamic acid, glycine, histidine, praline, serine, tyrosine, asparagine, and glutamine.

Preferred aminocarboxylic acids of the general formulae (IVa) and (IVb) are those in which s is an integer from 1 to 1000 and t is an integer from 1 to 4, preferably 1 or 2, and T has been selected from the group of phenylene and —(CH₂)ᵤ—, where u is 1, 5, or 12.

3f) can moreover also be a polyoxazoline of the general formula (V). However, 3f can also be a mixture of different aminocarboxylic acids and/or polyoxazolines.

In one preferred embodiment, the amounts that can be used of 3f) are from 0.01 to 50% by weight, preferably from 0.1 to 40% by weight, based on the total amount of components 1) and 2).

Among further components which can optionally be used for producing the semiaromatic polyesters are compounds 4a) which comprise at least three groups capable of ester formation.

The compounds 4a) preferably comprise from three to ten functional groups capable of forming ester bonds. Particularly preferred compounds 4a) have from three to six functional groups of this type within the molecule, in particular from three to six hydroxy groups and/or carboxy groups. Examples that may be mentioned are;

tartaric acid, citric acid, malic acid;

trimethylolpropane, trimethylolethane;

pentaerythritol;

polyethertriols;

glycerol;

trimesic acid;

trimellitic acid, trimellitic anhydride;

pyromellitic acid, pyromellitic dianhydride, and

hydroxyisophthalic acid.

The amounts used of the compounds 4a) are generally from 0.01 to 15 mol %, preferably from 0.05 to 10 mol %, particularly preferably from 0.1 to 4 mol %, based on component 1).

The component 4b) used comprises an, or a mixture of various, isocyanate(s). It is possible to use aromatic or aliphatic diisocyanates. However, it is also possible to use isocyanates of relatively high functionality.

For the purposes of the present invention, an aromatic diisocyanate 4b) is especially

tolylene 2,4-diisocyanate, tolylene 2,6-diisocyanate, diphenylmethane 2,2′-diisocyanate, diphenylmethane 2,4′-diisocyanate, diphenylmethane 4,4′-diisocyanate, naphthylene 1,5-diisocyanate, or xylylene diisocyanate.

Among these, particular preference is given to diphenylmethane 2,2′-, 2,4′- and 4,4′-diisocyanate as component 4b). The latter diisocyanates are generally used in the form of a mixture.

Tri(4-isocyanatophenyl)methane can also be used as trinuclear isocyanate 4b). Polynuclear aromatic diisocyanates are produced by way of example during production of mono- or binuclear diisocyanates.

Component 4b) can also comprise subordinate amounts of urethdione groups, e.g. up to 5% by weight, based on the total weight of component 4b), for example in order to cap the isocyanate groups.

For the purposes of the present invention, an aliphatic diisocyanate 4b) is especially a linear or branched alkylene diisocyanate or cycloalkylene diisocyanate having from 2 to 20 carbon atoms, preferably from 3 to 12 carbon atoms, e.g. hexamethylene 1,6-diisocyanate, isophorone diisocyanate, or methylene-bis(4-isocyanatocyclohexane). Particularly preferred aliphatic diisocyanates 4b) are hexamethylene 1,6-diisocyanate and isophorone diisocyanate.

Among the preferred isocyanurates are the aliphatic isocyanurates that derive from alkylene diisocyanates or from cycloalkylene diisocyanates having from 2 to 20 carbon atoms, preferably from 3 to 12 carbon atoms, e.g. isophorone diisocyanate or methylene-bis(4-isocyanatocyclohexane). The alkylene diisocyanates here can be either linear or branched. Particular preference is given to isocyanurates based on n-hexamethylene diisocyanate, for example cyclic trimers, pentamers, or higher oligomers of n-hexamethylene diisocyanate.

The amounts generally used of component 4b) are from 0.01 to 5 mol %, preferably from 0.05 to 4 mol %, particularly preferably from 0.1 to 4 mol %, based on the total of the molar amounts of 1) and 2).

The divinyl ethers 4c) used can generally comprise any of the divinyl ethers that are conventional and commercially available. It is preferable to use 1,4-butanediol divinyl ether, 1,6-hexanediol divinyl ether, or 1,4-cyclohexanedimethanol divinyl ether, or a mixture thereof.

The amounts preferably used of the divinyl ethers are from 0.01 to 5% by weight, in particular from 0.2 to 4% by weight, based on the total weight of 1) and 2).

Examples of preferred semiaromatic polyesters are based on the following components

1), 2), 4a)

1), 2), 4b)

1), 2), 4a), 4b)

1), 2), 4c)

1), 2), 3a)

1), 2), 3a), 4c)

1), 2), 3c), 3d)

1), 2), 3c), 3d), 3e)

1), 2), 4a), 3c), 3e)

1), 2), 3c), 4c)

1), 2), 3c), 4a)

1), 2), 3a), 3c), 4c)

1), 2), 3b)

Among these, particular preference is given to semiaromatic polyesters based on 1), 2), 4a), or 1), 2), 4b), or on 1), 2), 4a), 4b). In another preferred embodiment, the semiaromatic polyesters are based on 1), 2), 3c), 3d), 3e), or 1), 2), 4a), 3c), 3e).

Preference is given, as semiaromatic polyester A11, to a random copolyester composed of terephthalic acid (from 10-40 mol %), 1,4-butanediol (50 mol %) and adipic acid or sebacic acid (from 10-40 mol %), where the entirety of the monomers is 100% by weight. Particular preference is given to a random copolyester composed of terephthalic acid (from 15-35 mol %), 1,4-butanediol (50 mol %), and adipic acid (from 15-35 mol %), where the entirety of the monomers is 100% by weight.

The homo- or copolyester A12 has preferably been selected from the group consisting of polylactide (PLA), polycaprolacton, polyhydroxyalkanoates, such as PHB or PHBN, and polyester derived from aliphatic dicarboxylic acids and from aliphatic diols.

In one preferred embodiment, the melting point of at least one of the polyesters comprised in the plastics component A1 is lower than that of the polyesters B1 of the second plastics component B.

Advantage of the lower melting temperature is that incipient melting of the first plastics component A1 can give a particularly leakproof bond when the second plastics component B is injected over the material.

The first plastics component A1 can also comprise one or more additives. The additives here are usually those selected from the group consisting of impact modifiers, flame retardants, nucleating agents, carbon black, pigments, colorants, mold-release agents, heat-aging stabilizers, antioxidants, processing stabilizers, lubricants and antiblocking agents, waxes, plasticizers, surfactants, antistatic agents, and antifogging agents. The proportion of the additives, based on the mass of plastics component A1, is preferably in the range from 0 to 15% by weight.

The material can also comprise fibrous or particulate fillers. Suitable fibrous or particulate fillers can be inorganic or organic. Examples of suitable materials are glass fibers, carbon fibers, aramid fibers, kaolin, calcined kaolin, talc, chalk, silicates, mica, wollastonites, montmorillonites, cellulosic fibers, such as cotton, flax, hemp, nettle fibers, or the like, amorphous silica, and powdered quartz. Among the fibrous or particulate fillers, particular preference is given to the particulate fillers. Very particular preference is given to minerals and glass beads, in particular glass beads. The proportion of fibrous or particulate fillers, based on the mass of plastics component A1, is preferably in the range from 0 to 50% by weight. If the first plastics component A1 comprises glass beads, the proportion of the glass beads is preferably in the range from 0.1 to 40% by weight, based on the total weight of the first plastics component A1.

To improve compatibility with the first plastics component A1, the surface of the fillers can by way of example have been treated with an organic compound or with a silane compound.

Examples of suitable impact modifiers for the first plastics component A1 are copolymers composed of at least two monomer units selected from ethylene, propylene, butadiene, isobutene, isoprene, chloroprene, vinyl acetate, styrene, acrylonitrile, and acrylates and, respectively, methacrylates having from 1 to 18 C atoms in the alcohol component. Suitable impact modifiers are known by way of example from WO-A 2007/009930.

The first plastics component A1 can comprise amounts of from 0 to 50% by weight, based on the total mass of the first plastics component A, of flame retardants. Examples of suitable flame retardants are halogen-containing flame retardants, halogen-free flame retardants, melamine-cyanurate-based flame retardants, phosphorus-containing flame retardants, and flame retardants comprising expanded graphite.

According to the invention, plastics component A1 comprises at least one compatibilizer A13. The proportion of the at least one compatibilizer is preferably in the range from 0.05 to 5% by weight, in particular in the range from 0.1 to 3% by weight, in each case based on the total mass of plastics component A1.

The compatibilizers used can both improve the bonding of component A12 into the matrix of the semiaromatic polyester A11 or act as adhesion promoters between the first plastics component A1 and the second plastics component B. Examples of suitable compatibilizers are styrene (co)polymers grafted with glycidyl methacrylates, for example those described on pages 17-25 in Macromol. Symp. 2006, 233. Other suitable materials are styrene (co)polymers grafted with isocyanate groups, poly[methylene(phenylene isocyanate)], bisoxazolines, styrene copolymers grafted with oxazoline groups, or styrene copolymers grafted with maleic anhydride. Particularly suitable materials are styrene copolymers equipped with epoxy functionalities, with a proportion of methacrylic acid. Preference is given to random, epoxy-functionalized styrene-acrylic acid copolymers with a molar mass M_{w} of from 3000 to 8500 g/mol and functionalization by more than two epoxy groups per molecule chain. Particular preference is given to random, epoxy-functionalized styrene-acrylic acid copolymers with a molar mass M_{w} of from 5000 to 7000 g/mol and functionalization by more than four epoxy groups per molecule chain.

First Plastics Component A2

In accordance with the invention the first plastics component A2 is composed of:
A21: 10 to 100% by weight, based on the total weight of components A21 and A22, of at least one thermoplastics styrene (co)polymer,
A22: 0 to 90% by weight, based on the total weight of components A21 and A22, of at least one thermoplastic (co)polyester,
A23: 0.05 to 15% by weight, based on the total weight of components A21 and A22, a) of a copolymer which contains epoxy groups and which is based on styrene on acrylate, and/or on methacrylate, b) of a bisphenol A epoxide, or c) of a fatty acid amide, fatty acid ester, or natural oil containing epoxy groups.

In one preferred embodiment the first plastics component A2 comprises 50 to 100% by weight of the at least one thermoplastics styrene (co)polymer, and more particularly 70 to 100% by weight. Correspondingly, the proportion of the at least one thermoplastic (co)polyester is preferably 0 to 50% by weight and more particularly 0 to 30% by weight. In a particularly preferred embodiment there is 70 to 90% by weight of a thermoplastic styrene (co)polymer and 10 to 30% by weight of a thermoplastic (co)polyester.

The thermoplastic styrene (co)polymer A21 has preferably been selected from the group consisting of styrene-butadiene copolymers, styrene-acrylonitrile copolymers (SAN), □-methylstyrene-styrene-acrylonitrile copolymers, styrene-acrylonitrile copolymers with particulate rubber phase composed of diene polymers or alkyl acrylates, and α-methylstyrene-styrene-acrylonitrile copolymers with particulate rubber phase composed of diene polymers or alkyl acrylates, where the proportion comprised of each of the monomer units other than styrene in the copolymers is from 15 to 40% by weight.

Component A21 generally comprises from 15 to 60% by weight, preferably from 25 to 55% by weight, in particular from 30 to 50% by weight, of particulate graft rubber, and from 40 to 85% by weight, preferably from 45 to 75% by weight, in particular from 50 to 70% by weight, of thermoplastic styrene (co)polymer, where each of the percentages by weight has been based on the total weight of particulate graft rubber and of thermoplastic (co)polymer, and together these give 100% by weight.

The thermoplastic styrene (co)polymer A21 can also comprise α-methylstyrene or n-phenylmaleimide, with a proportion of from 0 to 70% by weight.

The proportions by weight of the monomer units other than styrene, or the proportion of the α-methylstyrene or n-phenylmaleimide, is always based here on the weight of the thermoplastic styrene (co)polymer A21.

In one preferred embodiment, the styrene component A21 comprises, as rubber phase, a particulate graft rubber based on butadiene, and, as thermoplastic hard phase, copolymers composed of vinylaromatic monomers and of vinyl cyanides (SAN), in particular composed of styrene and acrylonitrile, particularly preferably composed of styrene, □-methylstyrene, and acrylonitrile.

It is preferable that acrylonitrile-butadiene-styrene polymers (ABS) are used as SAN impact-modified with a particulate graft rubber.

ABS polymers are generally impact-modified SAN polymers in which diene polymers, in particular 1,3-polybutadiene, are present in a copolymer matrix composed in particular of styrene and/or α-methylstyrene and acrylonitrile. ABS polymers and their production are known to the person skilled in the art and are described in the literature, for example in DIN EN ISO 2580-1 DE of February 2003, WO 02/00745 and WO 2008/020012, and in Modern Styrenic Polymers, Edt. J. Scheirs, Wiley & Sons 2003, pp. 305-338.

The thermoplastic polyester A22 has preferably been selected from the group consisting of polyethylene terephthalate, polytrimethylene terephthalate, polybutylene terephthalate, and copolyesters composed of one or more diacids with one or more dials and, optionally, with one or more lactones, and also mixtures composed of at least two of said polyesters.

Examples of suitable diacids of which the copolyester is composed are those selected from the group consisting of terephthalic acid, adipic acid, isophthalic acid, 2,6-naphthalenedicarboxylic acid, acelaic acid, sebacic acid, dodecanedioic acids, cyclohexanedicarboxylic acids, and mixtures of these.

Examples of suitable dials of which the copolyester is composed are those selected from the group consisting of 1,2-ethanediol, 1,3-propanediol, 1,4-butanediol, pentanediol, 1,6-hexanediol, 1,4-hexanediol, 1,4-cyclohexanediol, 1,4-cyclohexanedimethanol, neopentyl glycol, polytetrahydrofuran, and mixtures of these.

If one or more lactones is/are also used in the structure of the copolyester, these are preferably those selected from the group consisting of ε-caprolactone, hexano-4-lactone, γ-butyrolactone, and γ-valerolactone.

Preference is given, as thermoplastic polyester A22, to a random copolyester composed of terephthalic acid (from 10-40 mol %), 1,4-butanediol (50 mol %) and adipic acid or sebacic acid (from 10-40 mol %), where the entirety of the monomers is 100% by weight. Particular preference is given to a random copolyester composed of terephthalic acid (from 15-35 mol %), 1,4-butanediol (50 mol %), and adipic acid (from 15-35 mol %), where the entirety of the monomers is 100% by weight.

In one preferred embodiment, at least one of the polyesters comprised in plastics component A2 has a lower melting point than the polyester B1 of the second plastics component B.

Advantage of the lower melting temperature is that incipient melting of the first plastics component A2 can give a particularly leakproof bond when the second component B is injected over the material.

The first plastics component A2 can also comprise one or more additives. The additives here are usually those selected from the group consisting of fibrous or particulate fillers, impact modifiers, flame retardants, nucleating agents, carbon black, pigments, colorants, mold-release agents, heat-aging stabilizers, antioxidants, processing stabilizers, and compatibilizers.

Examples of suitable fibrous fillers are glass fibers, carbon fibers, or aramid fibers. Examples of particulate fillers usually used are kaolin, calcined kaolin, talc, chalk, amorphous silica, and powdered quartz. Among the fibrous or particulate fillers, particular preference is given to the particulate fillers. Minerals and glass beads are very particularly preferred, in particular glass beads. If the first plastics component A2 comprises glass beads, the proportion of the glass beads is preferably in the range from 0.1 to 40% by weight, based on the total mass of the first plastics component A2.

To improve compatibility with the first plastics component A2, the surface of the fillers can by way of example have been treated with an organic compound or with a silane compound.

Examples of suitable impact modifiers for the first plastics component A2 are copolymers composed of at least two monomer units selected from ethylene, propylene, butadiene, isobutene, isoprene, chloroprene, vinyl acetate, styrene, acrylonitrile, and acrylates and, respectively, methacrylates having from 1 to 18 C atoms in the alcohol component. Suitable impact modifiers are known by way of example from WO-A 2007/009930,

The first plastics component A2 can comprise amounts of from 0 to 50% by weight, based on the total mass of the first plastics component A2, of flame retardants. Examples of suitable flame retardants are halogen-containing flame retardants, halogen-free flame retardants, melamine-cyanurate-based flame retardants, phosphorus-containing flame retardants, and flame retardants comprising expanded graphite.

In one particularly preferred embodiment, plastics component A2 comprises at least one compatibilizer. The proportion of the at least one compatibilizer is preferably in the range from 0.05 to 5% by weight, in particular in the range from 1 to 3% by weight, in each case based on the total mass of plastics component A2.

The compatibilizers used can both improve the bonding of component A22 into the matrix of the styrene (co)polymer A21 or act as adhesion promoters between the first plastics component A2 and the second plastics component B. Examples of suitable compatibilizers are styrene (co)polymers grafted with glycidyl methacrylates, for example those described on pages 17-25 in Macromol. Symp. 2006, 233. Other suitable materials are styrene (co)polymers grafted with isocyanate groups, poly[methylene(phenylene isocyanate)], bisoxazolines, styrene copolymers grafted with oxazoline groups, or styrene copolymers grafted with maleic anhydride. Particularly suitable materials are styrene copolymers equipped with epoxy functionalities, with a proportion of methacrylic acid. Preference is given to random, epoxy-functionalized styrene-acrylic acid copolymers with a molar mass M_{w} of from 3000 to 8500 g/mol and functionalization by more than two epoxy groups per molecule chain. Particular preference is given to random, epoxy-functionalized styrene-acrylic acid copolymer with a molar mass M_{w} of from 5000 to 7000 g/mol and functionalization by more than four epoxy groups per molecule chain.

Second Plastics Component B

As component B1, the molding compositions of the invention comprise 10 to 99.99%, preferably 30 to 97.99%, and more particularly 30 to 95% by weight of at least one thermoplastic polyester different from B22.

In general, polyesters B1 are used that are based on aromatic dicarboxylic acids and on an aliphatic or aromatic dihydroxy compound.

A first group of preferred polyesters are polyalkylene terephthalates, more particularly those having 2 to 10 C atoms in the alcohol moiety.

Polyalkylene terephthalates of this type are known per se and are described in the literature. Their main chain comprises an aromatic ring, deriving from the aromatic dicarboxylic acid. The aromatic ring can also have substitution, e.g. by halogen, such as chlorine or bromine, or by C₁-C₄-alkyl groups, such as methyl, ethyl, isopropyl, n-propyl, or n-butyl, isobutyl, or tert-butyl groups.

These polyalkylene terephthalates can be produced via reaction of aromatic dicarboxylic acids, or their esters or other ester-forming derivatives, with aliphatic dihydroxy compounds, in a manner known per se.

Preferred dicarboxylic acids are 2,6-naphthalenedicarboxylic acid, terephthalic acid, and isophthalic acid, or a mixture of these. Up to 30 mol %, of the aromatic dicarboxylic acids, preferably not more than 10 mol %, can be replaced by aliphatic or cycloaliphatic dicarboxylic acids, such as adipic acid, azelaic acid, sebacic acid, dodecanedioic acids, and/or cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, neopentyl glycol, or a mixture of these.

Particularly preferred polyesters B1 include polyalkylene terephthalates deriving from alkanediols having 2 to 6 C atoms. Of these, preference is given more particularly to polyethylene terephthalate, polypropylene terephthalate, and polybutylene terephthalate or mixtures thereof. Further preferred are PET and/or PBT comprising up to 1%, preferably up to 0.75%, by weight of 1,6-hexanediol and/or 2-methyl-1,5-pentanediol as further monomer units.

The viscosity number of the polyesters B1 is generally in the range from 50 to 220, preferably from 80 to 160 (measured in a 0.5% strength by weight solution in a phenol/o-dichlorobenzene mixtures (weight ratio 1:1 at 25° C.) in accordance with ISO 1628.

Particularly preferred are polyesters whose carboxyl end group content is up to 100 meq/kg, preferably up to 50 meq/kg, and in particular up to 40 meq/kg of polyester. Polyesters of this type may be prepared, for example, by the process of DE-A 44 01 055. The carboxyl end group content is determined typically by titration methods (e.g., potentiometry).

Particularly preferred molding compositions comprise as component B1 a mixture of PBT with polyesters different from PBT, such as polyethylene terephthalate (PET), for example. The fraction, for example, of the polyethylene terephthalate in the mixture is preferably up to 50%, more particularly 10% to 35%, by weight, based on 100% by weight of B1.

It is advantageous, furthermore, to use PET recyclates (also termed scrap PET), where appropriate in a mixture with polyalkylene terephthalates such as PBT.

Recyclates are understood in general to encompass the following:
1) post-industrial recyclate: this is production waste at the polycondensation stage or during processing, examples being sprues from injection-molding, start-up product in injection-molding or extrusion, or edge-cuts from extruded sheets or films.
2) Post-consumer recyclate: this comprises plastics articles collected after use by the end consumer and processed. By far the most significant articles in terms of quantity are blow-molded PET bottles for mineral water, soft drinks, and juices.

Both types of recyclate may take the form either of regrind or of pellets. In the latter case, the crude recyclates are first separated and cleaned and then melted in an extruder and pelletized. This usually facilitates handling, free-flow properties, and ease of metering for further processing steps.

Recyclates, in the form both of pellets and of regrind, can be employed, and the maximum edge length here should be not more than 10 mm, preferably not more than 8 mm.

Because of the hydrolytic cleavage of polyesters during processing (as a result of traces of moisture), it is advisable to predry the recyclate. The residual moisture content after drying is preferably not more than 0.2%, more particularly not more than 0.05%.

Another group to be mentioned is that of fully aromatic polyesters derived from aromatic dicarboxylic acids and aromatic dihydroxy compounds.

Suitable aromatic dicarboxylic acids are the compounds previously described for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from about 20 to about 50% of isophthalic acid.

The aromatic dihydroxy compounds preferably have the general formula (VI)

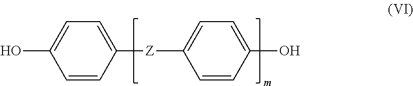

where Z is an alkylene or cycloalkylene group having up to 8 C atoms, an arylene group having up to 12 C atoms, a carbonyl group, a sulfonyl group, an oxygen or sulfur atom, or a chemical bond, and m is from 0 to 2. The phenylene groups of the compounds may also have substitution by C₁-C₆-alkyl or alkoxy groups and fluorine, chlorine or bromine.

Examples of parent compounds for these compounds are

dihydroxybiphenyl,

di(hydroxyphenyl)alkane,

di(hydroxyphenyl)cycloalkane,

di(hydroxyphenyl)sulfide,

di(hydroxyphenyl)ether,

di(hydroxyphenyl)ketone,

di(hydroxyphenyl)sulfoxide,

α,α′-di(hydroxyphenyl)dialkylbenzene,

di(hydroxyphenyl)sulfone, di(hydroxybenzoyl)benzene,

resorcinol, and

hydroquinone, and also the ring-alkylated and ring-halogenated derivatives of these.

Among these, preference is given to

4,4′-dihydroxybiphenyl,

2,4-di(4′-hydroxyphenyl)-2-methylbutane,

α,α′-di(4-hydroxyphenyl)-p-diisopropylbenzene,

2,2-di(3′-methyl-4′-hydroxyphenyl)propane, and

2,2-di(3′-chloro-4′-hydroxyphenyl)propane,

and in particular to

2,2-di(4′-hydroxyphenyl)propane

2,2-di(3′,5-dichlorodihydroxyphenyl)propane,

1,1-di(4′-hydroxyphenyl)cyclohexane,

3,4′-dihydroxybenzophenone,

4,4′-dihydroxydiphenyl sulfone and

2,2-di(3′,5′-dimethyl-4′-hydroxyphenyl)propane

and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

According to the invention, polyesters include halogen-free polycarbonates. Examples of suitable halogen-free polycarbonates are those based on diphenols of the general formula (VII)

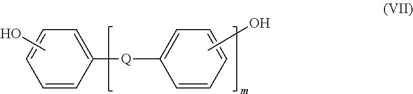

where Q is a single bond, a C₁-C₈-alkylene group, a C₂-C₃-alkylidene group, a C₃-C₆-cycloalkylidene group, a C₆-C₁₂-arylene group, or else —O—, —S—, or —SO₂—, and m is an integer from 0 to 2.

The phenylene radicals of the diphenols may also have substituents, such as C₁-C₆-alkyl or C₁-C₆-alkoxy.

Examples of preferred diphenols of the formula (VII) are hydroquinone, resorcinol, 4,4′-di-hydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component B1, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to average molecular weights M_{w} (weight-average) of from 10 000 to 200 000 g/mol, preferably from 20 000 to 80 000 g/mol.

The diphenols of the general formula (VII) are known per se or can be prepared by known processes.

The polycarbonates may, for example, be prepared by reacting the diphenols with phosgene in the interfacial process, or with phosgene in the homogeneous-phase process (known as the pyridine process), and in each case the desired molecular weight is achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates composed of halogen-free diphenols, of halogen-free chain terminators and, if used, halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components B1 which may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer with the trademark APEC HT®.

The molding compositions of the invention comprise, as component B2, from 0.01 to 50% by weight, preferably from 0.5 to 20% by weight, and in particular from 0.7 to 10% by weight, of at least one highly branched or hyperbranched polycarbonate, with an OH number of from 1 to 600 mg KOH/g polycarbonate, with preference from 10 to 550 mg KOH/g polycarbonate, and in particular from 50 to 550 mg KOH/g polycarbonate (to DIN 53240, part 2) as component B21, or of at least one hyperbranched polyester as component B22, or a mixture of these, as explained below.

For the purposes of this invention, hyperbranched polycarbonates B21 are non-crosslinked macromolecules having hydroxy groups and carbonate groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”. For the purposes of the present invention, the terms “highly branched” and “dendrimeric” are used synonymously.

Component B21 preferably has a number-average molecular mass Mₙ of from 100 to 15 000 g/mol, preferably from 200 to 12 000 g/mol, and in particular from 500 to 10 000 g/mol (GPC, PMMA standard).

The glass transition temperature Tg is in particular from −80° C. to +140° C., preferably from −60 to 120° C. (according to DSC, DIN 53765).

In particular, the viscosity (mPas) at 23° C. (to DIN 53019) is from 50 to 200 000, in particular from 100 to 150 000, and very particularly preferably from 200 to 100 000.

Component B21 is preferably obtainable via a process which comprises at least the following steps:
a) reaction of at least one organic carbonate (BA) of the general formula RO(CO)OR with at least one aliphatic alcohol (BB) which has at least 3 OH groups, with elimination of alcohols ROH to give one or more condensates (BK), where each R, independently of the others, is a straight-chain or branched aliphatic, araliphatic or aromatic hydrocarbon radical having from 1 to 20 C atoms, and
b) intermolecular reaction of the condensates (K) to give a highly functional, highly branched, or highly functional, hyperbranched polycarbonate,
   where the quantitative proportion of the OH groups to the carbonates in the reaction mixture is selected in such a way that the condensates (BK) have an average of either one carbonate group and more than one OH group or one OH group and more than one carbonate group.

Each of the radicals R of the organic carbonates (BA) used as starting material and having the general formula RO(CO)OR is, independently of the others, a straight-chain or branched aliphatic, araliphatic or aromatic hydrocarbon radical having from 1 to 20 C atoms. The two radicals R may also have bonding to one another to form a ring. The radical is preferably an aliphatic hydrocarbon radical, and particularly preferably a straight-chain or branched alkyl radical having from 1 to 5 C atoms.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol (BB) which has at least 3 OH groups, or with mixtures of two or more different alcohols.

Examples of compounds having at least three OH groups comprise glycerol, trimethylolmethane, trimethylolethane, trimethylolpropane, 1,2,4-butanetriol, tris(hydroxymethyl)amine, tris(hydroxyethyl)amine, tris(hydroxypropyl)amine, pentaerythritol, bis(trimethylolpropane), or sugars, e.g. glucose, trihydric or higher polyhydric polyetherols based on trihydric or higher polyhydric alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols (BB′), with the proviso that the average total OH functionality of all of the alcohols used is greater than 2. Examples of suitable compounds having two OH groups comprise ethylene glycol, diethylene glycol, triethylene glycol, 1,2- and 1,3-propanediol, dipropylene glycol, tripropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, difunctional polyetherols or polyesterols.

The reaction of the carbonate with the alcohol or alcohol mixture to give the inventive highly functional highly branched polycarbonate takes place generally with elimination of the monofunctional alcohol or phenol from the carbonate molecule.

The highly functional highly branched polycarbonates formed by the inventive process have termination by hydroxy groups and/or by carbonate groups after the reaction, i.e. with no further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a highly functional polycarbonate is a product which, besides the carbonate groups which form the polymer skeleton, further has at least three, preferably at least six, more preferably at least ten, terminal or pendant functional groups. The functional groups are carbonate groups and/or OH groups. There is in principle no upper restriction on the number of the terminal or pendant functional groups, but products having a very high number of functional groups can have undesired properties, such as high viscosity or poor solubility. The highly functional polycarbonates of the present invention mostly have not more than 500 terminal or pendant functional groups, preferably not more than 100 terminal or pendant functional groups.

When preparing the highly functional polycarbonates B21, it is necessary to adjust the ratio of the compounds comprising OH groups to the carbonate in such a way that the simplest resultant condensate (hereinafter termed condensate (BK)) comprises an average of either one carbonate group and more than one OH group or one OH group and more than one carbonate group. The simplest structure of the condensate (BK) composed of a carbonate (BA) and a di- or polyalcohol (BB) here results in the arrangement XYₙ or YₙX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate (BK) from a carbonate and a dihydric alcohol the reaction ratio is 1:1, the average result is a molecule of XY type, illustrated by the general formula 1.

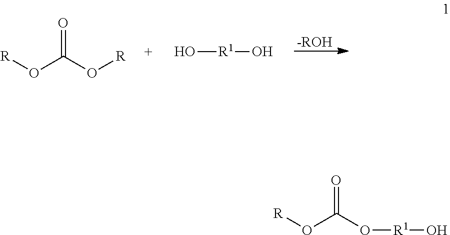

During the preparation of the condensate (BK) from a carbonate and a trihydric alcohol with a reaction ratio of 1:1, the average result is a molecule of XY₂ type, illustrated by the general formula 2. A carbonate group is focal group here.

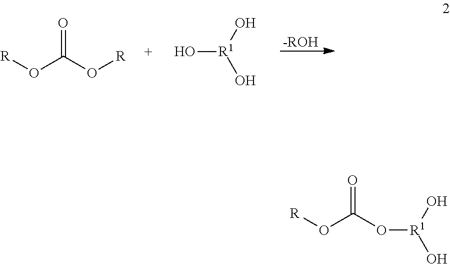

During the preparation of the condensate (BK) from a carbonate and a tetrahydric alcohol, likewise with the reaction ratio 1:1, the average result is a molecule of XY₃ type, illustrated by the general formula 3. A carbonate group is focal group here.

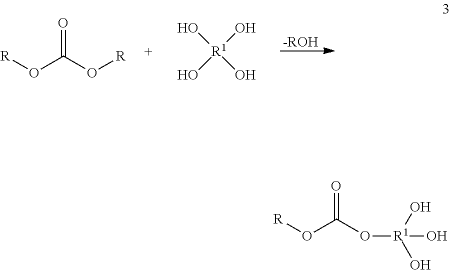

R in the formulae 1-3 has the definition given above for the organic carbonates (BA), and R¹ is an aliphatic radical.

The condensate (BK) may, by way of example, also be prepared from a carbonate and a trihydric alcohol, as illustrated by the general formula 4, the molar reaction ratio being 2:1. Here, the average result is a molecule of X₂Y type, an OH group being focal group here. In formula 4, R and R¹ are as defined in formulae 1-3.

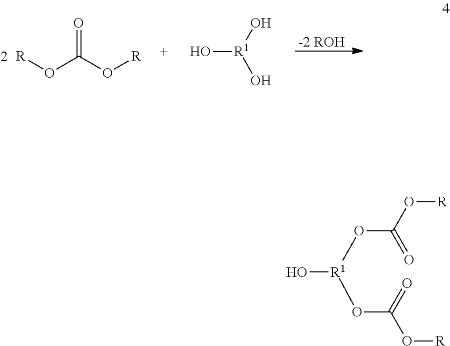

If difunctional compounds, e.g. a dicarbonate or a diol, are also added to the components, this extends the chains, as illustrated by way of example in the general formula 5. The average result is again a molecule of XY₂ type, a carbonate group being focal group.

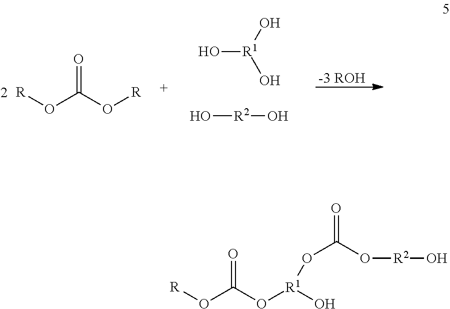

In formula 5, R² is an organic, preferably aliphatic radical, and R and R¹ are as defined above.

According to the invention, the simple condensates (BK) described by way of example in the formulae 1-5 preferentially react intermolecularly to form highly functional polycondensates, hereinafter termed polycondensates (BP). The reaction to give the condensate (K) and to give the polycondensate (BP) usually takes place at a temperature of from 0 to 250° C., preferably from 60 to 160° C., in bulk or in solution. Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one preferred embodiment, the condensation reaction is carried out in bulk. To accelerate the reaction, the phenol or the monohydric alcohol ROH liberated during the reaction can be removed by distillation from the reaction equilibrium if desired at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, of potassium, or of cesium, tertiary amines, guanidines, ammonium compounds, phosphonium compounds, organoaluminum, organotin, organozinc, organotitanium, organozirconium, or organobismuth compounds, or else what are known as double metal cyanide (DMC) catalysts, e.g. as described in DE 10138216 or DE 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, tin dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer (BP) may moreover be adjusted by way of the composition of the starting components and by way of the residence time.

The condensates (BK) and the polycondensates (BP) prepared at an elevated temperature are usually stable at room temperature for a relatively long period.

The nature of the condensates (BK) permits polycondensates (BP) with different structures to result from the condensation reaction, these having branching but no crosslinking. Furthermore, in the ideal case, the polycondensates (BP) have either one carbonate group as focal group and more than two OH groups or else one OH group as focal group and more than two carbonate groups. The number of the reactive groups here is the result of the nature of the condensates (BK) used and the degree of polycondensation.

By way of example, a condensate (BK) according to the general formula 2 can react via triple intermolecular condensation to give two different polycondensates (BP), represented in the general formulae 6 and 7.

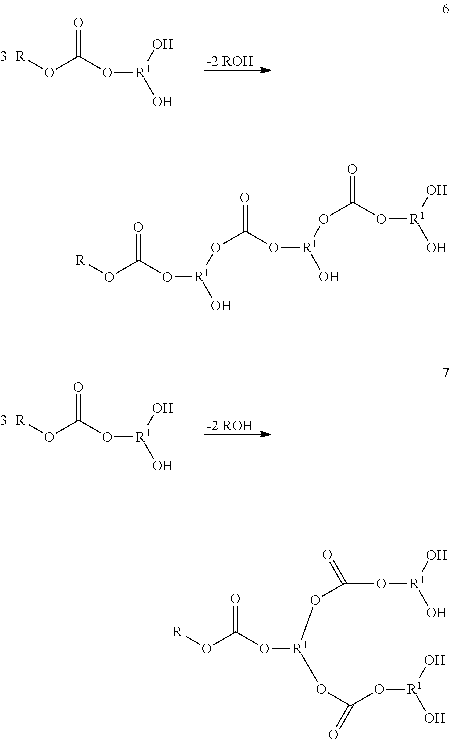

In formula 6 and 7, R and R¹ are as defined above in formulae 1-5.

There are various ways of terminating the intermolecular polycondensation reaction. By way of example, the temperature may be lowered to a range where the reaction stops and the product (BK) or the polycondensate (BP) is storage-stable.

In another embodiment, as soon as the intermolecular reaction of the condensate (BK) has produced a polycondensate (BP) with the desired degree of polycondensation, a product having groups reactive toward the focal group of (BP) may be added to the product (BP) to terminate the reaction. In the case of a carbonate group as focal group, by way of example, a mono-, di-, or polyamine may be added. In the case of a hydroxy group as focal group, by way of example, a mono-, di-, or polyisocyanate, or a compound comprising epoxy groups, or an acid derivative which reacts with OH groups, can be added to the product (BP).

The inventive highly functional polycarbonates are mostly prepared in a pressure range from 0.1 mbar to 20 bar, preferably at from 1 mbar to 5 bar, in reactors or reactor cascades which are operated batchwise, semicontinuously, or continuously.

The inventive products can be further processed without further purification after their preparation by virtue of the abovementioned adjustment of the reaction conditions and, optionally, by virtue of the selection of the suitable solvent.

In another preferred embodiment, the inventive polycarbonates may comprise other functional groups besides the functional groups present at this stage by virtue of the reaction. The functionalization may take place during the process to increase molecular weight, or else subsequently, i.e. after completion of the actual polycondensation.

If, prior to or during the process to increase molecular weight, components are added which have other functional groups or functional elements besides hydroxy or carbonate groups, the result is a polycarbonate polymer with randomly distributed functionalities other than the carbonate or hydroxy groups.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulfonic acids, derivatives of phosphonic acids, silane groups, siloxane groups, aryl radicals, or long-chain alkyl radicals, besides hydroxy groups or carbonate groups. Examples of compounds which may be used for modification by means of carbamate groups are ethanolamine, propanolamine, isopropanolamine, 2-(butylamino)ethanol, 2-(cyclohexylamino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethylethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups.

Subsequent functionalization can be achieved by using an additional step of the process (step c)) to react the resultant highly functional highly branched, or highly functional hyperbranched polycarbonate with a suitable functionalizing reagent which can react with the OH and/or carbonate groups of the polycarbonate.

By way of example, highly functional highly branched, or highly functional hyperbranched polycarbonates comprising hydroxy groups can be modified via addition of molecules comprising acid groups or isocyanate groups. By way of example, polycarbonates comprising acid groups can be obtained via reaction with compounds comprising anhydride groups.

Highly functional polycarbonates comprising hydroxy groups may moreover also be converted into highly functional polycarbonate polyether polyols via reaction with alkylene oxides, e.g. ethylene oxide, propylene oxide, or butylene oxide.

A great advantage of the process is its cost-effectiveness. Both the reaction to give a condensate (BK) or polycondensate (BP) and also the reaction of (BK) or (BP) to give polycarbonates with other functional groups or elements can take place in one reactor, this being advantageous technically and in terms of cost-effectiveness.

The inventive molding compositions may comprise, as component B22, at least one hyperbranched polyester of the AₓB_{y} type, where
x is at least 1.1, preferably at least 1.3, in particular at least 2
y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters B22 are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendant groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”. The term “highly branched” is used synonymously with “dendrimeric” in the context of the present invention.

Component B22 preferably has an Mₙ of from 300 to 30 000 g/mol, in particular from 400 to 25 000 g/mol, and very particularly from 500 to 20 000 g/mol, determined by means of GPC, PMMA standard, dimethylacetamide eluent.

B22 preferably has an OH number of from 0 to 600 mg KOH/g of polyester, preferably from 1 to 500 mg KOH/g of polyester, in particular from 20 to 500 mg KOH/g of polyester to DIN 53240, and preferably a COOH number of from 0 to 600 mg KOH/g of polyester, preferably from 1 to 500 mg KOH/g of polyester, and in particular from 2 to 500 mg KOH/g of polyester.

The T_{g} is preferably from −50° C. to 140° C., and in particular from −50 to 100° C. (by means of DSC, to DIN 53765).

Preference is particularly given to those components B22 in which at least one OH or COOH number is greater than 0, preferably greater than 0.1, and in particular greater than 0.5.

The inventive component B22 is in particular obtainable via the processes described below, specifically by reacting
(a) one or more dicarboxylic acids or one or more derivatives of the same with one or more at least trihydric alcohols

or
(b) one or more tricarboxylic acids or higher polycarboxylic acids or one or more derivatives of the same with one or more diols

in the presence of a solvent and optionally in the presence of an inorganic, organometallic, or low-molecular-weight organic catalyst, or of an enzyme. The reaction in solvent is the preferred preparation method.

For the purposes of the present invention, highly functional hyperbranched polyesters B22 have molecular and structural non-uniformity. Their molecular non-uniformity distinguishes them from dendrimers, and they can therefore be prepared at considerably lower cost.

Among the dicarboxylic acids which can be reacted according to variant (a) are, by way of example, oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid,

where the abovementioned dicarboxylic acids may have substitution by one or more radicals selected from

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl;

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned as representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (a) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably
the relevant anhydrides in monomeric or else polymeric form,
mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,
and also mono- and divinyl esters, and
mixed esters, preferably methyl ethyl esters.

In the preferred preparation process it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylolpropane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain component B22.

Examples of diols used for variant (b) of the present invention are ethylene glycol, propane-1,2-diol, propane-1,3-diol, butane-1,2-diol, butane-1,3-diol, butane-1,4-dial, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethylpentane-2,4-diol, 2-ethylhexane-1,3-diol, 2,5-dimethylhexane-2,5-diol, 2,2,4-trimethylpentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n≦4. One, or else both, hydroxy groups here in the abovementioned dials may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group can induce a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may derive either from chemical causes (e.g. primary/secondary/tertiary OH group) or from steric causes.

By way of example, the triol may comprise a trial which has primary and secondary hydroxy groups, a preferred example being glycerol.

When the inventive reaction is carried out according to variant (a), it is preferable to operate in the absence of diols and of monohydric alcohols.

When the inventive reaction is carried out according to variant (b), it is preferable to operate in the absence of mono- or dicarboxylic acids.

The inventive process is carried out in the presence of a solvent. By way of example, hydrocarbons are suitable, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Other solvents very particularly suitable in the absence of acidic catalysts are: ethers, such as dioxane or tetrahydrofuran, and ketones, such as methyl ethyl ketone and methyl isobutyl ketone.

According to the invention, the amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate decreases markedly at markedly lower concentrations of the reactants, giving uneconomically long reaction times.

To carry out the process preferred according to the invention, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water trap.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

For the purposes of the present invention, examples of acidic inorganic catalysts are sulfuric acid, phosphoric acid, phosphonic acid, hypophosphorous acid, aluminum sulfate hydrate, alum, acidic silica gel (pH=6, in particular=5), and acidic aluminum oxide. Examples of other compounds which can be used as acidic inorganic catalysts are aluminum compounds of the general formula Al(OR)₃ and titanates of the general formula Ti(OR)₄, where each of the radicals R may be identical or different and is selected independently of the others from

C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. Acidic ion exchangers may also be used as acidic organic catalysts, e.g. polystyrene resins comprising sulfonic acid groups and crosslinked with about 2 mol % of divinylbenzene.

It is also possible to use combinations of two or more of the abovementioned catalysts. It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The inventive process is carried out under inert gas, e.g. under carbon dioxide, nitrogen, or a noble gas, among which mention may particularly be made of argon.

The inventive process is carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred.

The pressure conditions for the inventive process are not critical per se. It is possible to operate at markedly reduced pressure, e.g. at from 10 to 500 mbar. The inventive process may also be carried out at pressures above 500 mbar. A reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. Reaction at atmospheric pressure is preferred.

The reaction time for the inventive process is usually from 10 minutes to 25 hours, preferably from 30 minutes to 10 hours, and particularly preferably from one to 8 hours.

Once the reaction has ended, the highly functional hyperbranched polyesters can easily be isolated, e.g. by removing the catalyst by filtration and concentrating the mixture, the concentration process here usually being carried out at reduced pressure. Other work-up methods with good suitability are precipitation after addition of water, followed by washing and drying.

Component B22 can also be prepared in the presence of enzymes or decomposition products of enzymes (according to DE-A 101 63163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geotrichum viscosum, Geotrichum candidum, Mucor javanicus, Mucor mihei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known per se, e.g. from Kurt Faber, “Biotransformations in organic chemistry”, 3rd edition 1997, Springer Verlag, Chapter 3.2 “immobilization” pp. 345-356. Immobilized enzymes are commercially available, for example from Novozymes Biotech Inc., Denmark.

The amount of immobilized enzyme used is from 0.1 to 20% by weight, in particular from 10 to 15% by weight, based on the total weight of the starting materials used and to be reacted.

The inventive process is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The inventive process is carried out in the presence of a solvent. Examples of suitable compounds are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The inventive process is carried out at pressures above 500 mbar. Preference is given to the reaction at atmospheric pressure or slightly increased pressure, for example at up to 1200 mbar. It is also possible to operate under markedly increased pressure, for example at pressures up to 10 bar. The reaction at atmospheric pressure is preferred.

The reaction time for the inventive process is usually from 4 hours to 6 days, preferably from 5 hours to 5 days, and particularly preferably from 8 hours to 4 days.

Once the reaction has ended, the highly functional hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The highly functional, hyperbranched polyesters obtainable by the inventive process feature particularly low contents of discolored and resinified material. For the definition of hyperbranched polymers, see also: P. J. Flory, J. Am. Chem. Soc. 1952, 74, 2718, and A. Sunder et al., Chem. Eur. J. 2000, 6, no. 1, 1-8. However, in the context of the present invention, “highly functional hyperbranched” means that the degree of branching, i.e. the average number of dendritic linkages plus the average number of end groups per molecule, is from 10 to 99.9%, preferably from 20 to 99%, particularly preferably from 30 to 90% (see in this connection H. Frey et al. Acta Polym. 1997, 48, 30).

The inventive polyesters have a molecular weight M_{w} of from 500 to 50 000 g/mol, preferably from 1000 to 20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the inventive polyesters in tetrahydrofuran (THF), n-butyl acetate, ethanol, and numerous other solvents, with no gel particles detectable by the naked eye.

The inventive highly functional hyperbranched polyesters are carboxy-terminated, carboxy- and hydroxy-terminated, and preferably hydroxy-terminated.

The ratios of the components B21:B22 are preferably from 1:20 to 20:1, in particular from 1:15 to 15:1, and very particularly from 1:5 to 5:1 if a mixture of these is used.

The hyperbranched polycarbonates B21/polyesters B22 used are particles with a size of 20-500 nm. These nanoparticles are in fine division in the polymer blend; the size of the particles in the compounded material is from 20 to 500 nm, preferably from 50 to 300 nm.

Compounded materials of this type are available commercially, e.g. in the form of Ultradur® high speed.

Impact-Modified Polymer D

As component D, the plastics component B may comprise from 1 to 40% by weight, preferably from 1 to 20% by weight, of an impact-modifying polymer (often also termed elastomeric polymer or elastomer).

Preferred elastomeric polymers are polymers based on olefins, composed of the following components:
D1 from 40 to 100% by weight, preferably from 55 to 79.5% by weight, of at least one α-olefin having from 2 to 8 carbon atoms,
D2 from 0 to 90% by weight of a diene,
D3 from 0 to 45% by weight, preferably from 20 to 40% by weight, of a C₁-C₁₂-alkyl ester of acrylic acid or methacrylic acid, or a mixture of these esters,
D4 from 0 to 40% by weight, preferably from 0.5 to 20% by weight, of an ethylenically unsaturated mono- or dicarboxylic acid, or of a functional derivative of this acid,
D5 from 0 to 40% by weight of a monomer containing epoxy groups,
D6 from 0 to 5% by weight of other monomers capable of free-radical polymerization,

with the proviso that component D is not an olefin homopolymer, because use of that material, e.g. polyethylene, does not achieve the advantageous effects to the same extent.

A first preferred class is that of the rubbers known as ethylene-propylene (EPM) and ethylene-propylene-diene (EPDM) rubbers, which preferably have a ratio of ethylene units to propylene units in the range from 40:60 to 90:10.

The Mooney viscosities (MLI+4/100° C.) (measured with the large rotor after a running time of 4 minutes at 100° C., according to DIN 53 523) of such, preferably not crosslinked, EPM or EPDM rubbers (gel contents generally below 1% by weight) are preferably in the range from 25 to 100, in particular from 35 to 90.

EPM rubbers generally have practically no remaining double bonds, whereas EPDM rubbers may have from 1 to 20 double bonds per 100 C atoms.

Examples of diene monomers D2 for EPDM rubbers are conjugated dienes, such as isoprene and butadiene, non-conjugated dienes with from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadiene, cyclooctadiene and dicyclopentadiene, and also alkenylnorbornenes, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0.2.6]-3,8-decadiene or mixtures of these. Preference is given to 1,5-hexadiene, 5-ethylidenenorbornene and dicyclopentadiene. The diene content of the EPDM rubbers is preferably from 0.5 to 50% by weight, in particular from 2 to 20% by weight and particularly preferably from 3 to 15% by weight, based on the total weight of the olefin polymer.

EPM or EPDM rubbers may preferably also have been grafted with reactive carboxylic acids or derivatives of these. Particular mention may be made here of acrylic acid, methacrylic acid and derivatives of these, and also maleic anhydride.

Examples of particularly preferred components D are MBS rubbers composed of:

from 65 to 99% by weight of a core composed of
D2 from 90 to 100% by weight of a diene, and from 0 to 10% by weight of other crosslinkable monomers,
   and from 1 to 35% by weight of a shell composed of
D7 from 1 to 30% by weight of styrene or of unsaturated styrenes, or a mixture of these, and
D8 from 70 to 100% by weight of at least one unsaturated nitrile.

Suitable monomers D7 are styrenes or substituted styrenes of the general formula (VIII)

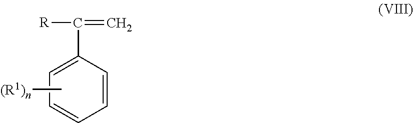

where R is a C₁-C₈-alkyl radical, preferably methyl or ethyl, or hydrogen, and R¹ is a C₁-C₈-alkyl radical, preferably methyl or ethyl, and n is 1, 2, or 3, or a mixture of these.

Another group of preferred olefin polymers is that of copolymers of α-olefins having from 2 to 8 C atoms, in particular of ethylene, with C₁-C₁₈-alkyl esters of acrylic acid and/or methacrylic acid.

In principle, any of the primary, secondary, or tertiary C₁-C₁₈-alkyl esters of acrylic acid or methacrylic acid is suitable, but preference is given to esters having from 1 to 12 C atoms, in particular having from 2 to 10 C atoms.

Examples of these are methyl, ethyl, propyl, n-butyl, isobutyl, tert-butyl, 2-ethylhexyl, octyl, and decyl(meth)acrylates. Among these, particular preference is given to n-butyl acrylate and 2-ethylhexyl acrylate.

The proportion of the methacrylic esters and acrylic esters D3 in the olefin polymers is from 0 to 60% by weight, preferably from 10 to 50% by weight, and in particular from 30 to 45% by weight.

Other monomers which may be present instead of the esters D3, or in addition to these, in the olefin polymers are monomers having acid functionality and/or having latent acid functionality, these being derived from ethylenically unsaturated mono- or dicarboxylic acids 04, or monomers D5 containing epoxy groups.

Examples which may be mentioned of monomers D4 are acrylic acid, methacrylic acid, tertiary alkyl esters of these acids, in particular tert-butyl acrylate, and dicarboxylic acids, such as maleic acid and fumaric acid, or derivatives of these acids, and also their monoesters.

Monomers having latent acid functionality are compounds which form free acid groups under the conditions of the polymerization process, or during incorporation of the olefin polymers into the molding compositions. Examples which may be mentioned of these are anhydrides of dicarboxylic acids having up to 20 C atoms, in particular maleic anhydride, and tertiary C₁-C₁₂-alkyl esters of the abovementioned acids, in particular tert-butyl acrylate and tert-butyl methacrylate.

The monomers having acid functionality or having latent acid functionality, and the monomers containing epoxy groups, are preferably incorporated into the olefin polymers via addition of compounds of the general formulae (XI)-(XII) to the monomer mixture.

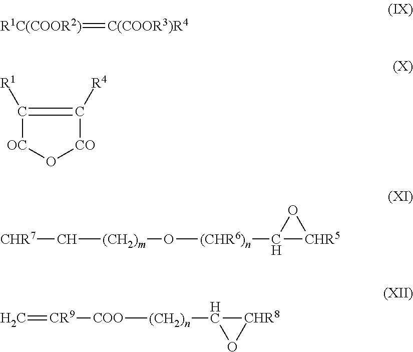

where the radicals R¹-R⁹ are hydrogen or alkyl groups having from 1 to 6 C atoms, and m is a whole number from 0 to 20, and n is a whole number from 0 to 10.

R¹-R⁷ are preferably hydrogen, m is preferably 0 or 1, and n is preferably 1. The corresponding compounds are maleic acid, fumaric acid, maleic anhydride, D4, or alkenyl glycidyl ether or vinyl glycidyl ether D5.

Preferred compounds of the formulae (IX), (X), (XI) and (XII) are maleic acid and maleic anhydride as component D4 and epoxy-containing esters of acrylic acid and/or methacrylic acid, particular preference being given to glycidyl acrylate and glycidyl methacrylate (as component D5).

The proportion of each of the components D4 and D5 is from 0.07 to 40% by weight, in particular from 0.1 to 20% by weight, and particularly preferably from 0.15 to 15% by weight, based on the total weight of the olefin polymers.

Particular preference is given to olefin polymers composed of

from 50 to 98.9% by weight, in particular from 55 to 65% by weight, of ethylene,

from 0.1 to 20% by weight, in particular from 0.15 to 10% by weight, of glycidyl acrylate and/or glycidyl methacrylate, acrylic acid, and/or maleic anhydride,

from 1 to 45% by weight, in particular from 25 to 40% by weight, of n-butyl acrylate and/or 2-ethylhexyl acrylate, and

from 0 to 10% by weight, in particular from 0.1 to 3% by weight, of maleic anhydride or fumaric acid, or a mixture of these.

Other preferred esters of acrylic and/or methacrylic acid are the methyl; ethyl, propyl, isobutyl, and tert-butyl esters.

Examples of other monomers D6 are vinyl esters and vinyl ethers.

If these olefin polymers are used, their proportion is preferably from 0 to 20% by weight, in particular from 4 to 18% by weight, and very particularly from 5 to 15% by weight, based on the total weight of all the components.

The ethylene copolymers described above may be prepared by processes known per se, preferably via random copolymerization at high pressure and at elevated temperature.

The melt index of the ethylene copolymers is generally in the range from 1 to 80 g/10 min (measured at 190° C. and 2.16 kg load).

Preference is also given to acrylate rubbers D composed of:
a) from 70 to 90% by weight, preferably from 75 to 85% by weight, of crosslinked elastomeric core, composed of:
1) from 20 to 90% by weight of a core composed of a copolymer (I) of an n-alkyl acrylate whose alkyl group has from 5 to 12 carbon atoms and preferably from 5 to 8 carbon atoms, or of a mixture of alkyl acrylates, where the number of the carbon atoms in straight-chain or branched alkyl groups is in the range from 2 to 12 and preferably from 4 to 8; of a polyfunctional crosslinking agent, where this molecule has unsaturated groups and, among these, at least one CH₂═C<group of vinyl type, and, optionally, is composed of a polyfunctional grafting agent, where this molecule has unsaturated groups and, among these, at least one CH₂═CH—CH₂— group of allyl type, where the core contains a molar amount of the crosslinking agent and, optionally, of the grafting agent, of from 0.05 to 5%, the amount preferably being from 0.5 to 1.5% by weight,
2) from 80 to 10% by weight of a shell which is composed of a copolymer (II) of an n-alkyl acrylate whose alkyl group has from 4 to 12 carbon atoms and preferably from 4 to 8 carbon atoms, or of a mixture of alkyl acrylates as defined under 1), and of a polyfunctional grafting agent, where this molecule has unsaturated groups and, among these, at least one CH₂═CH—CH₂— group of allyl type, where the shell contains a molar amount of from 0.05 to 2.5% of the grafting agent, the amount preferably being from 0.5 to 1.5% by weight, and
b) from 30 to 10% by weight, and preferably from 26 to 15% by weight, of a shell, grafted onto the core and composed of an alkyl methacrylate polymer whose alkyl group has from 1 to 4 carbon atoms, or composed of a random copolymer of an alkyl methacrylate whose alkyl group has from 1 to 4 carbon atoms with an alkyl acrylate whose alkyl group has from 1 to 8 carbon atoms, the molar amount present of the alkyl acrylate being from 5 to 40%, and preferably in the range from 10 to 20%.

By way of illustration of the n-alkyl acrylates which according to the present invention may be used to form the copolymer (I), use may be made of n-pentyl acrylate, n-hexyl acrylate, n-heptyl acrylate, and in particular n-octyl acrylate.

Examples of n-alkyl acrylates which may be used according to the invention to form the copolymer (II) are n-butyl acrylate, n-pentyl acrylate, n-hexyl acrylate, n-heptyl acrylate, and in particular n-octyl acrylate.

The n-alkyl acrylates which may be used to form the copolymers (I) and/or (II) may be identical or different.

By way of illustration of the straight-chain or branched alkyl acrylates which may be used according to the invention to form the mixtures of alkyl acrylates in the copolymers (I) and/or (II), use may be made of ethyl acrylate, n-propyl acrylate, n-butyl acrylate, amyl acrylate, 2-methylbutyl acrylate, 2-ethylhexyl acrylate, n-hexyl acrylate, n-octyl acrylate, n-decyl acrylate, n-dodecyl acrylate, and 3,5,5-trimethylhexyl acrylate.

If a mixture of alkyl acrylates is used to form the copolymers (I) and/or (II), the proportion used of the n-alkyl acrylate should be at least 10% by weight of the mixture of alkyl acrylates, this amount preferably being in the range from 20 to 80%.

As stated above, identical or different mixtures of alkyl acrylates may be used to prepare the copolymers (I) and/or (II).

According to the present invention, it is preferable to use n-alkyl acrylates, and in particular n-octyl acrylate, to prepare the copolymers (I) and (II).

If a mixture of alkyl acrylates is used to form the copolymers (I) and/or (II), the amount used is preferably from 20 to 80% by weight of n-octyl acrylate and preferably from 80 to 20% by weight of n-butyl acrylate.

Examples of alkyl methacrylates which may be used according to the present invention to form the shell grafted onto the crosslinked elastomeric core are ethyl methacrylate, n-propyl methacrylate, isopropyl methacrylate; n-butyl methacrylate, isobutyl acrylate, and particularly methyl methacrylate.

The crosslinking agent used to form the copolymer (I) may according to the present invention be selected in particular from the derivatives which have at least two double bonds of vinyl type or have one or more double bonds of vinyl type and have at least one double bond of allyl type. It is preferable to use compounds whose molecules mainly contain double bonds of vinyl type.

By way of illustration of these crosslinking agents, mention may be made of the divinylbenzenes, (meth)acrylates of polyalcohols, e.g. trimethylolpropane triacrylate, trimethylolpropane trimethacrylate, allyl acrylate, allyl methacrylate, diacrylates or methacrylates of alkylene glycols having from 2 to 10 carbon atoms in the alkylene chain, and in particular ethylene glycol diacrylate, ethylene glycol dimethacrylate, butane-1,4-diol diacrylate, butane-1,4-dimethacrylate, hexene-1,6-diol diacrylate, hexane-I,6-dimethacrylate, the diacrylate or dimethacrylate of polyoxyalkylene glycol of the following formula:

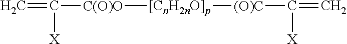

where X is hydrogen or methyl, n is a whole number from 2 to 4, and p is a whole number from 2 to 20, and in particular the diacrylate or dimethacrylate of polyoxyethylene glycol where the polyoxyethylene group has a molecular weight of about 400 (formula given above, where n=2 and p=9).

The grafting agent used for preparing the copolymer (II) may according to the present invention in particular be selected from the derivatives which have at least two double bonds of allyl type or have one or more double bonds of allyl type and have at least one double bond of vinyl type.

It is preferable to use compounds whose molecules mainly contain double bonds of allyl type.

Examples of these grafting agents which may be used are diallyl maleate, diallyl itaconate, allyl acrylate, allyl methacrylate, triallyl cyanurate, triallyl isocyanurate, diallyl terephthalate, and triallyl trimesate.

The preferred proportion of the impact modifier introduced into the thermoplastic polymer is in the range from 1 to 30% by weight and preferably from 5 to 10% by weight, based on 100% by weight of the thermoplastic polymer used.

The molecular weight of the impact modifier may be assessed by defining a melt viscosity, which has the same range of variation. The melt viscosity may be within a fairly wide range, with the proviso that good dispersion of the impact modifier is ensured during the operations of use of the resin composition with the modifier. A suitable variable representing this melt viscosity is the value of the moment of resistance in a Brabender rheometer which comprises 50 g of impact modifier and is operated at a temperature of 200° C., the rotation rate of the rotors being 40 rpm, and the torque being determined at 200° C. after 20 min. Suitable values for the melt viscosity of the impact modifier correspond to values in the range from 600 to 4000 Nm for the abovementioned torque. For resin compositions in which the thermoplastic polymer is a polymer with at least 80% by weight of polymerized vinyl chloride, the preferred values for the melt viscosity of the impact modifier correspond to torque values in the range in 800 to 3000 Nm, and in particular in the range from 1000 to 2500 Nm.

EP-A 776 915 discloses processes for the preparation of these components D.

Graft Polymer E

Amounts of from 1 to 60% by weight, based on the entirety of all the components, of a graft copolymer or of a mixture of different graft copolymers are used as component E in the plastics component B in one embodiment. Preferred molding compositions of the invention comprise from 2 to 50% by weight, particularly preferably from 3 to 40% by weight, of at least one graft copolymer E, which differs from elastomeric polymers used as impact modifiers D.

The graft polymers E are composed of
E1 from 20 to 80% by weight, preferably from 50 to 70% by weight, of a graft base composed of an elastomeric polymer based on alkyl acrylates having from 1 to 8 C atoms in the alkyl radical and having a glass transition temperature below 0° C.
E2 from 20 to 80% by weight, preferably from 30 to 50% by weight, of a graft composed of
E21 from 60 to 95% by weight, preferably from 70 to 85% by weight, of styrene or of substituted styrenes of the general formula (XIII)

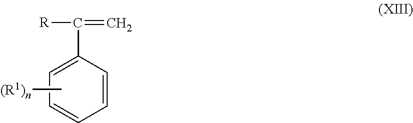

where R is a C₁-C₈-alkyl radical, preferably methyl or ethyl, or hydrogen, and R¹ is a C₁-C₈-alkyl radical, preferably methyl or ethyl, and n is 1, 2, or 3, or a mixture of these, and
E22 from 5 to 40% by weight, preferably from 15 to 30% by weight, of at least one unsaturated nitrite, preferably acrylonitrile or methacrylonitrile, or a mixture of these.

Polymers which may be used for the graft base E1 are those whose glass transition temperature is below 10° C., preferably below 0° C., particularly preferably below −20° C. Examples of these are elastomers based on C₁-C₈-alkyl esters of acrylic acid, which, if desired, may comprise other comonomers.

Preferred graft bases E1 are those composed of
E11 from 70 to 99.9% by weight, preferably 99% by weight, of at least one alkyl acrylate having from 1 to 8 C atoms in the alkyl radical, preferably n-butyl acrylate and/or 2-ethylhexyl acrylate, in particular n-butyl acrylate as sole alkyl acrylate,
E12 from 0 to 30% by weight, in particular from 20 to 30% by weight, of another copolymerizable monoethylenically unsaturated monomer, e.g. butadiene, isoprene, styrene, acrylonitrile, methyl methacrylate, or vinyl methyl ether, or a mixture of these,
E13 from 0.1 to 5% by weight, preferably from 1 to 4% by weight, of a copolymerizable, polyfunctional, preferably bi- or trifunctional, monomer which brings about crosslinking.
Suitable bi- or polyfunctional crosslinking monomers E13 here are those which preferably comprise two, or optionally three or more, ethylenic double bonds capable of copolymerization and not conjugated in 1,3-positions. Examples of suitable crosslinking monomers are divinylbenzene, diallyl maleate, diallyl fumarate, diallyl phthalate, triallyl cyanurate, or triallyl isocyanurate. The acrylic ester of tricyclodecenyl alcohol has proven to be a particularly advantageous crosslinking monomer (cf. DE-A 12 60 135).

This type of graft base is known per se and described in the literature, e.g. in DE-A 31 49 358.

Among the grafts E2, preference is given to those in which E21 is styrene or α-methylstyrene or a mixture of these, and in which E22 is acrylonitrile or methacrylonitrile. Preferred monomer mixtures used are especially styrene and acrylonitrile or α-methylstyrene and acrylonitrile. The grafts are obtainable via copolymerization of components E21 and E22.

The graft base E1 of the graft polymers E is composed of the components E11, if desired E12, and E22, and is also termed ASA rubber. Its preparation is known per se and is described by way of example in DE-A 28 26 925, DE-A 31 49 358, and DE-A 3414 118.

The graft polymers E may be prepared by the method described in DE-C 12 60 135 for example.

The construction of the graft (graft shell) of the graft polymers may involve one or two stages.

In the case of single-stage construction of the graft shell, a mixture of the monomers E21 and E22 in the desired ratio by weight in the range from 95:5 to 50:50, preferably from 90:10 to 65:35, is polymerized in the presence of the elastomer E1, in a manner known per se (cf., for example, DE-A 28 26 925), preferably in emulsion.

In the case of two-stage construction of the graft shell E2, the 1st stage generally makes up from 20 to 70% by weight, preferably from 25 to 50% by weight, based on E2. Its preparation preferably uses only styrene or substituted styrenes, or a mixture of these (E11).

The 2nd stage of the graft shell generally makes up from 30 to 80% by weight, in particular from 50 to 75% by weight, based in each case on E2. Its preparation uses mixtures composed of the monomers E21 and of the nitriles E22, in a E21/E22 ratio by weight which is generally from 90:10 to 60:40, in particular from 80:20 to 70:30.

The selection of the conditions for the graft polymerization process is preferably such that the particle sizes obtained are from 50 to 700 nm (d₅₀ value of the integral mass distribution). Measures for this purpose are known and are described by way of example in DE-A 2826925.

The seed latex process can be used directly to prepare a coarse-particle rubber dispersion.

In order to obtain products of maximum toughness, it is often advantageous to use a mixture of at least two graft polymers with different particle size.

To achieve this, the particles of the rubber are enlarged in a known manner, e.g. via agglomeration, thus giving the latex a bimodal composition (from 50 to 180 nm and from 200 to 700 nm).

One preferred embodiment uses a mixture composed of two graft polymers with particle diameters (d₅₀ value of the integral mass distribution) of from 50 to 180 nm and, respectively, from 200 to 700 nm, in a ratio of from 70:30 to 30:70 by weight.

The chemical structure of the two graft polymers is preferably identical, but the shell of the coarse-particle graft polymer may in particular also be constructed in two stages.

Mixtures of components where the latter comprises a coarse- and fine-particle graft polymer are described by way of example in DE-A 36 15 607, Mixtures composed of the components where the latter comprise a two-stage graft shell are known from EP-A 111 260.

The inventive molding compositions may comprise, as component F, from 0 to 60% by weight, based on the entirety of all the components, of at least one copolymer based on styrene or on substituted styrenes, and on unsaturated nitrites. Preferred inventive molding compositions comprise proportions of from 1 to 45% by weight, in particular from 2 to 40% by weight, of component F, based on the entirety of all the components.

According to the invention, the copolymers F are composed of
F1 from 60 to 95% by weight, preferably from 70 to 85% by weight, of styrene or of substituted styrenes of the general formula (XIII), or a mixture of these, and
F2 from 5 to 40% by weight, preferably from 15 to 30% by weight, of at least one unsaturated nitrile, preferably acrylonitrile or methacrylonitrile or a mixture of these.

The copolymers F are resin-like, thermoplastic, and rubber-free. Particularly preferred copolymers F are those composed of styrene and acrylonitrile, of α-methylstyrene and acrylonitrile, or of styrene, α-methylstyrene, and acrylonitrile. It is also possible to make simultaneous use of two or more of the copolymers described.

The copolymers F are known per se and may be prepared via free-radical polymerization, in particular via emulsion, suspension, solution, or bulk polymerization. They have viscosity numbers in the range from 40 to 160, corresponding to average molecular weights M_{w} (weight-average) of from 40 000 to 2 000 000.

Halogenated Flame Retardants G

The plastics components A1, A2 and/or B may comprise, as component G, from 1 to 30% by weight, preferably from 2 to 25% by weight, and in particular from 5 to 20% by weight, of a flame retardant combination composed of
G1 from 20 to 99% by weight, preferably from 50 to 85% by weight, of a halogen-containing flame retardant,
G2 from 1 to 80% by weight, preferably from 15 to 50% by weight, of an antimony oxide.

Preferred oxides G2 are antimony trioxide and antimony pentoxide. For better dispersion, the oxide G2 may be incorporated in what are known as batches (concentrates) into the polymer A1, A2 or B, and polymers used in this concentrate may, by way of example, be the same as component A1, A2 or B or different from the respective component A1, A2 or B. Preference is given to concentrates of G2 in polyolefins, preferably polyethylene.

Suitable flame retardants G1 are preferably brominated compounds, such as brominated diphenyl ethers, brominated trimethylphenylindanes (FR 1808 from DSB), tetra-bromobisphenol A, and hexabromocyclododecane.

Suitable flame retardants 31 are preferably brominated compounds, such as brominated oligocarbonates (BC 52 or BC 58 from Great Lakes) of the structural formula:

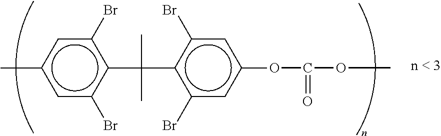

Polypentabromobenzyl acrylates, where n>4 e.g. FR 1025 from Dead Sea Bromine (DSB) of the formula:

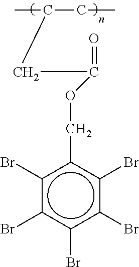

are also suitable.

Other preferred brominated compounds are oligomeric reaction products (n>3) derived from tetrabromobisphenol A with epoxides (e,g. FR 2300 and 2400 from DSB) of the formula:

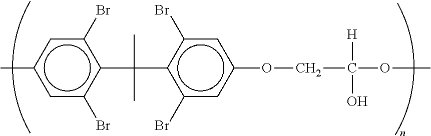

The brominated oligostyrenes preferably used as flame retardant have an average degree of polymerization (number-average) of from 3 to 90, preferably from 5 to 60, measured by vapor pressure osmometry in toluene. Cyclic oligomers are likewise suitable. In one preferred embodiment of the invention, the brominated oligomeric styrenes to be used have the following formula (XIV), where R is hydrogen or an aliphatic radical, in particular an alkyl radical, such as CH₂ or C₂H₅, and n is the number of repeat units in the chain. R′ can be either H or else bromine or else a fragment of a customary free-radical generator:

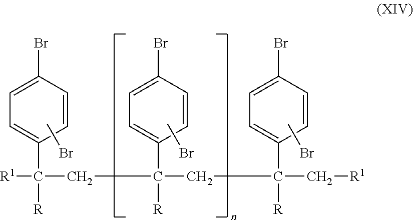

The value n can be from 1 to 88, preferably from 3 to 58. The brominated ollgostyrenes contain from 40 to 80% by weight of bromine, preferably from 55 to 70% by weight. Preference is given to a product which is composed mainly of polydibromostyrene. The substances can be melted without decomposition and, by way of example, are tetrahydrofuran-soluble. They may be prepared either via ring bromination of—optionally aliphatically hydrogenated—styrene oligomers, such as those obtainable via thermal polymerization of styrene (to DT-A 25 37 385) or via free-radical oligomerization of suitable brominated styrenes. The flame retardant may also be prepared via ionic oligomerization of styrene followed by bromination. The amount of brominated oligostyrene needed to render the polyamides flame retardant depends on the bromine content. The bromine content in the inventive molding compositions is from 2 to 20% by weight, preferably from 5 to 12% by weight.

The brominated polystyrenes of the invention are usually obtained by the process described in EP-A 47 549:

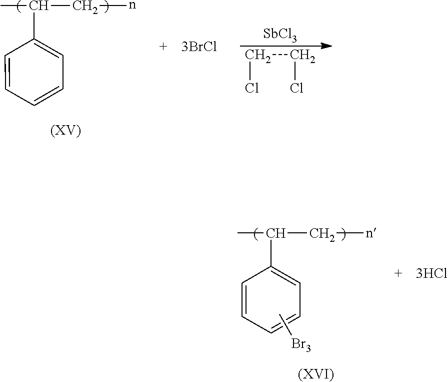

The brominated polystyrenes obtainable by this process and available commercially are mainly ring-substituted tribrominated products. n′ (see XVI) generally has values of from 125 to 1500, corresponding to a molecular weight of from 42 500 to 235 000, preferably from 130 000 to 135 000.

The bromine content (based on the content of ring-substituted bromine) is generally at least 50% by weight, preferably at least 60% by weight, and in particular 65% by weight.

The pulverulent products obtainable commercially generally have a glass transition temperature of from 160 to 200° C. and are available, by way of example, with the names HP 7010 from Albemarle and Pyrocheck PB 68 from Ferro Corporation.

It is also possible to use mixtures of the brominated oligostyrenes with brominated polystyrenes in the inventive molding compositions, in any desired mixing ratio.

Chlorine-containing flame retardants D1 are also suitable, and Deklorane® plus from Oxychem is preferred.

Halogen-Free Flame Retardants H

The plastics components A1, A2 and/or B may comprise, as component H, from 1 to 40% by weight, preferably from 2 to 30% by weight, and in particular from 5 to 20% by weight, of a halogen-free flame retardant selected from the group of the nitrogen-containing or phosphorus-containing compounds or of the P/N condensates, or a mixture of these.

The melamine cyanurate preferably suitable according to the invention as halogen-free flame retardant H is a product of reaction of preferably equimolar amounts of melamine (formula (XVI)) and cyanuric acid or isocyanuric acid (formulae (XVIa) and (XVIb)).

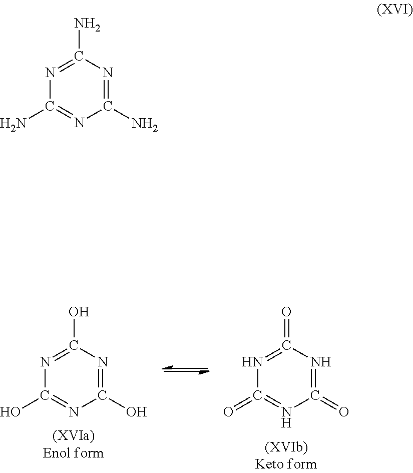

It is obtained, for example, via reaction of aqueous solutions of the starting compounds at from 90 to 100° C. The product available commercially is a white powder with a d₅₀ average grain size of from 1.5 to 7 μm.

Other suitable compounds (also often termed salts or adducts) are melamine, melamine borate, melamine oxalate, melamine phosphate (prim.), melamine phosphate (sec.) and melamine pyrophosphate (sec.), melamine neopentyl glycol borate and polymeric melamine phosphate (CAS No. 56386-64-2).

Suitable guanidine salts are

| | CAS No. |
|---|---|
| G carbonate | 593-85-1 |
| G cyanurate (prim.) | 70285-19-7 |
| G phosphate (prim.) | 5423-22-3 |
| G phosphate (sec.) | 5423-23-4 |
| G sulfate (prim.) | 646-34-4 |
| G sulfate (sec.) | 594-14-9 |
| Guanidine pentaerythritol borate | N.A. |
| Guanidine neopentyl glycol borate | N.A. |
| and | |
| Urea phosphate green | 4861-19-2 |
| Urea cyanurate | 57517-11-0 |
| Ammeline | 645-92-1 |
| Ammelide | 645-93-2 |
| Melem | 1502-47-2 |
| Melon | 32518-77-7 |

For the purposes of the present invention the compounds include both benzoguanamine itself and its adducts or salts, and also the derivatives substituted on nitrogen and their adducts or salts.

Another suitable compound is ammonium polyphosphate (NH₄PO₃)ₙ, where n is from about 200 to 1000, preferably from 600 to 800, and tris(hydroxyethyl) isocyanurate (THEIC) of the formula XVII

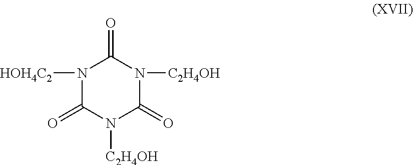

or its reaction products with aromatic carboxylic acids Ar(COOH)ₘ, in mixtures with one another if desired, where Ar is a mono-, bi- or trinuclear aromatic six-membered ring system and m is 2, 3 or 4.

Examples of suitable carboxylic acids are phthalic acid, isophthalic acid, terephthalic acid, benzene-1,3,5-tricarboxylic acid, benzene-1,2,4-tricarboxylic acid, pyromellitic acid, mellophanic acid, prehnitic acid, 1-naphthoic acid, 2-naphthoic acid, naphthalenedicarboxylic acids, and anthracenecarboxylic acids.

They are prepared by reacting the tris(hydroxyethyl) isocyanurate with the acids, or with their alkyl esters or their halides in accordance with the process of EP-A 584 567.

Reaction products of this type are a mixture of monomeric and oligomeric esters which may also have crosslinking. The degree of oligomerization is usually from 2 to about 100, preferably from 2 to 20. Preference is given to the use of THEIC and/or its reaction products in mixtures with phosphorus-containing nitrogen compounds, in particular (NH₄PO₃)ₙ or melamine pyrophosphate or polymeric melamine phosphate. The mixing ratio, for example of (NH₄PO₃)ₙ to THEIC, is preferably 90-50:10-50% by weight, in particular 80-50:50-20% by weight, based on the mixture of components H of this type.

Other suitable compounds are benzoguanamines of the formula (XVIII):

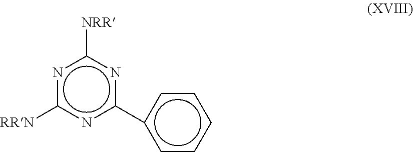

where R and R′ are straight-chain or branched alkyl radicals having from 1 to 10 C atoms, preferably hydrogen and in particular their adducts with phosphoric acid, boric acid and/or pyrophosphoric acid.

Preference is also given to allantoin compounds of the formula (XIX)

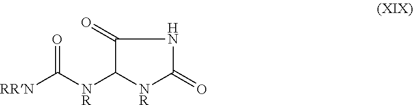

where R and R′ are as defined in formula (XVIII), and also to the salts of these with phosphoric acid, boric acid and/or pyrophosphoric acid, and also to glycolurils of the formula (XX) and to their salts with the abovementioned acids

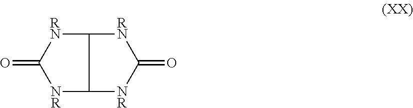

where R is as defined in formula (XVIII).

Suitable products are obtainable commercially or in accordance with DE-A 196 14 424.

The cyanoguanidine (formula (XXI)) which can be used according to the invention is obtained, for example, by reacting calcium cyanamide with carbonic acid, whereupon the cyanamide produced dimerizes at a pH of from 9 to 10 to give cyanoguanidine.

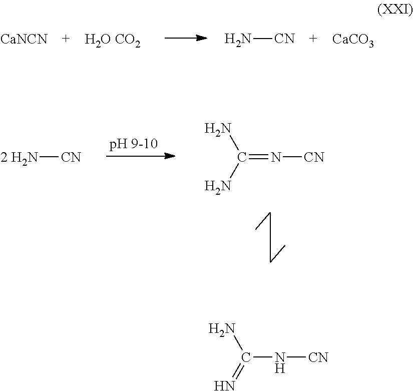

The product obtainable commercially is a white powder with a melting point of from 209° C. to 211° C.

Preferred phosphorus-containing compounds are phosphinic salts of the formula (XXII) and/or diphosphinic salts of the formula (XXIII), and/or their polymers

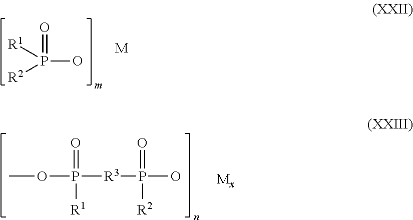

where the substituents are defined as follows:
R¹ and R² are hydrogen, C₁-C₆-alkyl, preferably C₁-C₄-alkyl, linear or branched, e.g. methyl, ethyl, n-propyl, isopropyl, n-butyl, tert-butyl, n-pentyl; phenyl; where at least one radical R¹ or R² is preferably hydrogen and in particular R¹ and R² are hydrogen;
R³ is C₁-C₁₀-alkylene, linear or branched, e.g. methylene, ethylene, n-propylene, isopropylene, n-butylene, tert-butylene, n-pentylene, n-octylene, n-dodecylene;
   arylene, e.g. phenylene, naphthylene;
   alkylarylene, e.g. methylphenylene, ethylphenylene, tert-butylphenylene, methylnaphthylene, ethylnaphthylene, tert-butylnaphthylene;
   arylalkylene, e.g. phenylrnethylene, phenylethylene, phenylpropylene, phenylbutylene;
M is an alkaline earth metal or alkali metal, Al, Zn, Fe, Bor;
m is a whole number from 1 to 3;
n is a whole number from 1 to 3, and
x is 1 or 2.

Particular preference is given to compounds of the formula (XXIII) in which R¹ and R² are hydrogen, where M is preferably Zn or Al and very particular preference is given to calcium phosphinate.

Products of this type are commercially available, e.g. as calcium phosphinate.

Suitable salts of the formula (XXII) or (XXIII) in which only one radical R¹ or R² is hydrogen are, for example, salts of phenylphosphinic acid, its Na and/or Ca salts being preferred.

The phosphorus-containing compounds of component H are preferably organic or inorganic phosphorus-containing compounds where the phosphorus has a valence state of from −3 to +5. For the purposes of the invention the valence state is the oxidation state as given in Lehrbuch der Anorganischen Chemie, by A. F. Hollemann and E. Wiberg, Walter des Gruyter and Co. (1964, 57th to 70th edition), pages 166-177. Phosphorus compounds of the valence states from −3 to +5 derive from phosphine (−3), diphosphine (−2), phosphine oxide (−1), elemental phosphorus (+0), hypophosphorous acid (+1), phosphorous acid (+3), hypodiphosphoric acid (+4) and phosphoric acid (+5).

Only a few examples will be mentioned from the large number of phosphorus-containing compounds.

Examples of phosphorus compounds of the phosphine class, which have the valence state −3, are aromatic phosphines, such as triphenylphosphine, tritolylphosphine, trinonylphosphine, trinaphthylphosphine and trisnonylphenylphosphine inter alia. Triphenyl-phosphine is particularly suitable.

Examples of phosphorus compounds of the diphosphine class, having the valence state −2, are tetraphenyldiphosphine and tetranaphthyldiphosphine inter alia. Tetranaphthyldiphosphine is particularly suitable.

Phosphorus compounds of the valence state −1 derive from phosphine oxide.

Phosphine oxides of the general formula (XXIV) are suitable

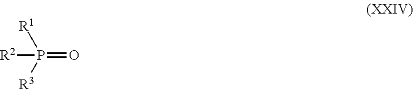

where R¹, R² and R³ are identical or different and are alkyl, aryl, alkylaryl or cycloalkyl groups having from 8 to 40 C atoms.

Examples of phosphine oxides are triphenylphosphine oxide, tritolylphosphine oxide, trisnonylphenylphosphine oxide, tricyclohexyiphosphine oxide, tris(n-butyl)phosphine oxide, tris(n-hexyl)phosphine oxide, tris(n-octyl)phosphine oxide, tris(cyanoethyl)phosphine oxide, benzylbis(cyclohexyl)phosphine oxide, benzylbisphenylphosphine oxide and phenylbis(n-hexyl)phosphine oxide. Other preferred compounds are oxidized reaction products of phosphine and aldehydes, in particular of tert-butylphosphine with glyoxal. Particular preference is given to the use of triphenylphosphine oxide, tricyclohexylphosphine oxide, tris(n-octyl)phosphine oxide or tris(cyanoethyl)phosphine oxide.

Other suitable compounds are triphenylphosphine sulfide and its derivatives as described above for phosphine oxides.

Phosphorus of the valence state ±0 is elemental phosphorus. Red and black phosphorus are possible, and red phosphorus is preferred.

Examples of phosphorus compounds of the oxidation state +1 are hypophosphites of purely organic type, e.g. organic hypophosphites such as cellulose hypophosphite esters and esters of hypophosphorous acids with diols, e.g. that of 1,10-dodecyldiol. It is also possible to use substituted phosphinic acids and anhydrides of these, e.g. diphenylphosphinic acid. Other possible compounds are diphenylphosphinic acid, di-p-tolylphosphinic acid and dicresylphosphinic anhydride. Compounds such as the bis(diphenylphosphinic) esters of hydroquinone, ethylene glycol and propylene glycol, inter alia, may also be used. Other suitable compounds are aryl(alkyl)phosphinamides, such as the dimethylamide of diphenylphosphinic acid, and sulfonamidoaryl(alkyl)phosphinic acid derivatives, such as p-tolylsulfonamidodiphenylphosphinic acid. Preference is given to use of the bis(diphenylphosphinic)ester of hydroquinone or of ethylene glycol, or bis(diphenylphosphinate) of hydroquinone.

Phosphorus compounds of the oxidation state +3 derive from phosphorous acid. Suitable compounds are cyclic phosphonates which derive from pentaerythritol, neopentyl glycol or pyrocatechol, for example

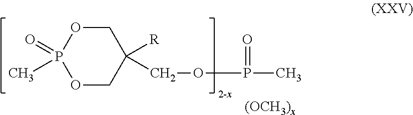

where R is a C₁-C₄-alkyl radical, preferably methyl radical, and x is 0 or 1 (Amgard® P 45 from Albright & Wilson).

Phosphorus of the valence state +3 is also present in triaryl(alkyl) phosphites, such as triphenyl phosphite, tris(4-decylphenyl)phosphite, tris(2,4-di-tert-butylphenyl)phosphite and phenyldidecyl phosphite. It is also possible, however, to use diphosphites, such as propylene glycol 1,2-bis(diphosphite) or cyclic phosphites which derive from pentaerythritol, from neopentyl glycol or from pyrocatechol.

Particular preference is given to neopentyl glycol methylphosphonate and neopentyl glycol methylphosphite, and also to pentaerythritol dimethyldiphosphonate and dimethyl pentaerythritol diphosphite.

Phosphorus compounds of oxidation state +4 which may be used are particularly hypodiphosphates, such as tetraphenyl hypodiphosphate and bisneopentyl hypodiphosphate.

Phosphorus compounds of oxidation state +5 which may be used are particularly alkyl- and aryl-substituted phosphates. Examples of these are phenyl bisdodecyl phosphate, phenylethyl hydrogenphosphate, phenylbis(3,5,5-trimethylhexyl)phosphate, ethyldiphenyl phosphate, 2-ethylhexylditolyl phosphate, diphenyl hydrogenphosphate, bis(2-ethylhexyl)-p-tolyl phosphate, tritolyl phosphate, bis(2-ethylhexyl)phenyl phosphate, di(nonyl)phenyl phosphate, phenylmethyl hydrogenphosphate, didodecyl-p-tolyl phosphate, p-tolylbis(2,5,5-trimethylhexyl)phosphate and 2-ethylhexyldiphenyl phosphate. Particularly suitable phosphorus compounds are those in which each radical is aryloxy. Very particularly suitable compounds are triphenyl phosphate and resorcinol bis(diphenyl phosphate) and its ring-substituted derivatives of the general formula (XXVI) (RDP):

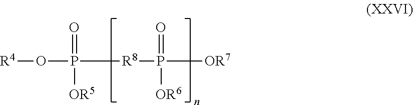

where:
R⁴-R⁷ are aromatic radicals having from 6 to 20 carbon atoms, preferably phenyl, which may have substitution by alkyl groups having from 1 to 4 carbon atoms, preferably methyl,
R⁸ is a bivalent phenol radical, preferably

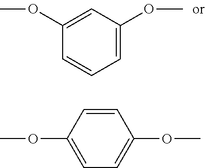

and n has an average value of from 0.1 to 100, preferably from 0.5 to 50, in particular from 0.8 to 10 and very particularly from 1 to 5.

Due to the process used for their manufacture, RDP products available commercially under the trade name Fyroflex® or Fyrol®-RDP (Akzo) and also CR 733-S (Daihachi) are mixtures of about 85% of RDP (n=1) with about 2.5% of triphenyl phosphate and also about 12.5% of oligomeric fractions in which the degree of oligomerization is mostly less than 10.

It is also possible to use cyclic phosphates. Of these, diphenyl pentaerythritol diphosphate and phenylneopentyl phosphate are particularly suitable.

Besides the low-molecular-weight phosphorus compounds mentioned above, it is also possible to use oligomeric or polymeric phosphorus compounds.

Polymeric, halogen-free organic phosphorus compounds of this type with phosphorus in the polymer chain are produced, for example, in the preparation of pentacyclic unsaturated phosphine dihalides, as described, for example, in DE-A 20 36 173. The molecular weight of the polyphospholine oxides, measured by vapor pressure osmometry in dimethylformamide, should be in the range from 500 to 7000, preferably from 700 to 2000.

Phosphorus here has the oxidation state −1.

It is also possible to use inorganic coordination polymers of aryl(alkyl)phosphinic acids, such as poly-β-sodium(I) methylphenylphosphinate. Their preparation is given in DE-A 31 40 520. Phosphorus has the oxidation number +1.

Halogen-free polymeric phosphorus compounds of this type may also be produced by the reaction of a phosphonic acid chloride, such as phenyl-, methyl-, propyl-, styryl- or vinylphosphonyl dichloride, with dihydric phenols, such as hydroquinone, resorcinol, 2,3,5-trimethylhydroquinone, bisphenol A, or tetramethylbisphenol A.

Other halogen-free polymeric phosphorus compounds which may be present in the novel molding compositions are prepared by reacting phosphorus oxytrichioride or phosphoric ester dichlorides with a mixture of mono-, di- or trihydric phenols and other compounds carrying hydroxy groups (cf. Houben-Weyl-Müller, Thieme-Verlag, Stuttgart, Germany, Organische Phosphorverbindungen Part II (1963)). It is also possible to produce polymeric phosphonates via transesterification reactions of phosphonate esters with dihydric phenols (cf. DE-A 29 25 208) or via reactions of phosphonate esters with diamines, or with diamides or hydrazides (cf. U.S. Pat. No. 4,403,075). The inorganic compound poly(ammonium phosphate) may also be used.

It is also possible to use oligomeric pentaerythritol phosphites, pentaerythritol phosphates and pentaerythritol phosphonates, in accordance with EP-B 8 486, for example Mobil Antiblaze® 19 (registered trade mark of Mobil Oil).

Preference is also given to phosphorus compounds of the general formula (XXVII)

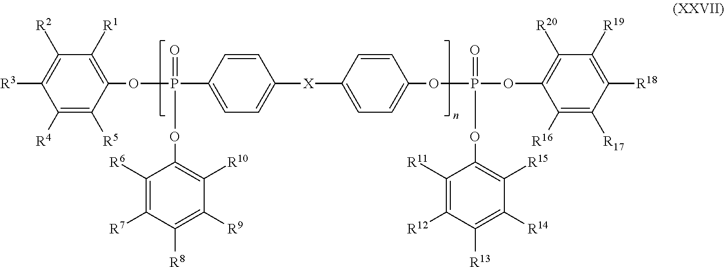

in which the substituents are defined as follows:
R¹-R²⁰, independently of one another, are hydrogen, a linear or branched alkyl group up to 6 C atoms
n has an average value of from 0.5 to 50, and
X is a single bond, C═O, S, SO₂, C(CH₃)₂.

Preferred compounds H are those in which R¹ to R²⁰, independently of one another, are hydrogen and/or a methyl radical. If R¹-R²⁰, independently of one another, are a methyl radical, preference is given to those compounds H in which the radicals R¹, R⁵, R⁶, R¹⁰, R¹¹, R¹⁵, R¹⁶, R²⁰ in ortho-position with respect to the oxygen of the phosphate group are at least one methyl radical. Preference is also given to compounds H in which one methyl group is present per aromatic ring, preferably in ortho-position, and the other radicals are hydrogen.

Particularly preferred substituents are SO₂ and S, and C(CH₃)₂ is very particularly preferred for X in the above formula (XXVII).

The average value of n is preferably from 0.5 to 5, in particular from 0.7 to 2, and in particular ≈1.

The statement of n as an average value is a consequence of the preparation process for the compounds listed above, the degree of oligomerization mostly being smaller than 10 and the content of triphenyl phosphate present being very small (mostly <5% by weight), there being a difference here from batch to batch. The compounds H are commercially available as CR-741 from Daihachi.

P/N condensates are also suitable, particularly those described in WO 2002/96976.

Particularly preferred combinations H are mixtures of phosphorus- and nitrogen-containing compounds, preferred mixing ratios being from 1:10 to 10:1, preferably from 1:9 to 9:1.

Adjuvants C

The plastics components A1, A2 ad/or B may comprise, as component C, from 0 to 60% by weight, in particular up to 50% by weight, of other additives and processing aids which are different from D, E, F, G and H.

The inventive molding compositions may comprise, as component C, from 0 to 5% by weight, preferably from 0.05 to 3% by weight, and in particular from 0.1 to 2% by weight, of at least one ester or amide of saturated or unsaturated aliphatic carboxylic acids having from 10 to 40, preferably from 16 to 22, C atoms with saturated aliphatic alcohols or amines having from 2 to 40, preferably from 2 to 6, C atoms.

The carboxylic acids may be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 C atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glyceryl distearate, glyceryl tristearate, ethylenediamine distearate, glyceryl monopalmitate, glyceryl trilaurate, glyceryl monobehenate, and pentaerythrityl tetrastearate.

It is also possible to use mixtures of various esters or amides, or esters with amides combined, the mixing ratio here being as desired.

Fibrous or particulate fillers C which may be mentioned are carbon fibers, glass fibers, glass beads, amorphous silica, asbestos, calcium silicate, calcium metasilicate, magnesium carbonate, kaolin, chalk, powdered quartz, mica, barium sulfate and feldspar, used in amounts of up to 50% by weight, in particular up to 40% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₂₋ₖ

where:
X NH₂—,

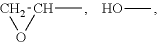

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.05 to 5% by weight, preferably from 0.5 to 1.5% by weight and in particular from 0.8 to 1% by weight (based on C),

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if desired, have been pretreated with the abovementioned silane compounds, but the pretreatment is not essential.

Other fillers which may be mentioned are kaolin, calcined kaolin, wollastonite, talc and chalk.

As component C, the thermoplastic molding compositions of the invention may comprise the usual processing aids, such as stabilizers, oxidation retarders, agents to counteract decomposition due to heat and decomposition due to ultraviolet light, lubricants and mold-release agents, colorants, such as dyes and pigments, nucleating agents, plasticizers, etc.

Examples which may be mentioned of oxidation retarders and heat stabilizers are sterically hindered phenols and/or phosphites, hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron, oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

Other lubricants and mold-release agents are usually used in amounts of up to 1% by weight. Preference is given to long-chain fatty acids (e.g. stearic acid or behenic acid), salts of these (e.g. calcium stearate or zinc stearate) or montan waxes (mixtures of straight-chain saturated carboxylic acids having chain lengths of from 28 to 32 C atoms), or calcium montanate or sodium montanate, or low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils and N-(n-butyl)benzenesulfonamide.

The inventive molding compositions may also comprise from 0 to 2% by weight of fluorine-containing ethylene polymers. These are polymers of ethylene with a fluorine content of from 55 to 76% by weight, preferably from 70 to 76% by weight.

Examples of these are polytetrafluoroethylene (PTFE), tetrafluoroethylene-hexafluoropropylene copolymers and tetrafluoroethylene copolymers with relatively small proportions (generally up to 50% by weight) of copolymerizable ethylenically unsaturated monomers. These are described, for example, by Schildknecht in “Vinyl and Related Polymers”, Wiley-Verlag, 1952, pages 484-494 and by Wall in “Fluoropolymers” (Wiley Interscience, 1972).

These fluorine-containing ethylene polymers have homogeneous distribution in the molding compositions and preferably have a particle size d₅₀ (numeric average) in the range from 0.05 to 10 μm, in particular from 0.1 to 5 μm. These small particle sizes can particularly preferably be achieved by the use of aqueous dispersions of fluorine-containing ethylene polymers and the incorporation of these into a polyester melt.

The inventive thermoplastic molding compositions may be prepared by methods known per se, by mixing the starting components in conventional mixing apparatus, such as screw extruders, Brabender mixers or Banbury mixers, and then extruding them. The extrudate may then be cooled and comminuted. It is also possible to premix individual components and then to add the remaining starting materials individually and/or likewise in a mixture. The mixing temperatures are generally from 230 to 290° C.

Component and Production Method

An example of the component is a plastics part used in electrical engineering, a mechatronic component, or a plastics casing with plug-in contacts.

An example of the insert part enclosed by the plastics jacketing is a stamped grid. In that case, the component can be used for example as plug connector. The insert part can moreover be a wire, a round conductor, a flat conductor, a flexible foil, or a printed circuit board.

If the component is used in the automobile industry sector, the insert part can, for example, also be a retaining strap, a door latch, a lock, a threaded bush, an antifriction bearing, a panel, a wire for stabilizers, or a component composed of diecast zinc or diecast aluminum for a door-securing unit. It is moreover also possible that the component is a blade for a knife, for scissors, for a scalpel, or else for a screwdriver.

The insert part has preferably been manufactured from a metal. Examples of suitable metals from which the insert part has been manufactured are copper and copper-containing alloys, such as CuSn6, CuSn0,15, CuBe, CuFe, CuZn37, CuSn4Zn6Pb3-C-GC (gunmetal) or CuZn39Pb3 (brass), aluminum and aluminum-containing alloys, such as AlSi12Cu1, AlSi10Mg, titanium, stainless steel, lead-free metals, and metal alloys, or materials with a tin coating.

The invention further provides a process for the production of a component comprising an insert part and plastics jacketing composed of at least two plastics components, where the process comprises the following steps:
(a) sheathing of an insert part with a first plastics component A1, where the first plastics component A1 is composed of:
A11: from 5 to 80% by weight, based on the total weight of components A11 and A12, of at least one polyester based on aliphatic and aromatic dicarboxylic acids and on aliphatic dihydroxy compounds;
A12: 20 to 95% by weight, based on the total weight of components A11 and A12, of at least one homo- or copolyester selected from the group consisting of polylactide (PLA), polycaprolacton, polyhydroxyalkanoates, and polyester derived from aliphatic dicarboxylic acids and aliphatic diols;
A13: 0.05 to 15% by weight, based on the total weight of components A11 and A12, a) of a copolymer which contains epoxy groups and which is based on styrene, on acrylate, and/or on methacrylate, b) of a bisphenol A epoxide, or c) of a fatty acid amide, fatty acid ester, or natural oil containing epoxy groups,
or with a first plastics component A2, where the first plastics component A2 is composed of:
A21: 10 to 100% by weight, based on the total weight of components A21 and A22, of at least one thermoplastics styrene(co)polymer,
A22: 0 to 90% by weight, based on the total weight of components A21 and A22, of at least one thermoplastic(co)polyester,
A23: 0.05 to 15% by weight, based on the total weight of components A21 and A22, a) of a copolymer which contains epoxy groups and which is based on styrene on acrylate, and/or on methacrylate, b) of a bisphenol A epoxide, or c) of a fatty acid amide, fatty acid ester, or natural oil containing epoxy groups,
(b) molding of exterior sheathing composed of a second plastics component B, where the second plastics component B is composed of:
B1: 10 to 99.99% by weight of at least one thermoplastic polyester,
B2: 0.01 to 50% by weight of
   B21: at least one highly branched or hyperbranched polycarbonate having an OH number of 1 to 600 mg KOH/g polycarbonate (as per DIN 53249, Part 2)
   or
   B22: at least one highly branched or hyperbranched polyester of the type AₓB_{y} where x is at least 1.1 and y is at least 2.1,
   or mixtures thereof,
it being further possible for the first plastics component A1 or the first plastics component A2 and/or the second plastics component B to comprise:
C 0 to 60% by weight of at least one further adjuvant,

and where either the insert part is first sheathed with the first plastics component A1 or A2 and then the second plastics component B is applied, or the exterior sheathing B is first molded, and then the first plastics component A1 or A2 is charged to a cavity formed between the exterior sheathing, composed of the second plastics component B, and the insert part, in order to form the sheathing of the insert part.

Suitable and preferred polymers as first plastics component A1, first plastics component A2, and second plastics component B have already been described above.

In one preferred embodiment, an injection-molding process is used for the sheathing of the insert part with the first plastics component A1 or A2 in a step (a). For this, the insert part is placed in an injection mold. Once the insert part has been placed, the mold is closed and the plastics molding composition is injected into the mold. The plastics molding composition at least partially sheaths the insert part and forms an adhesive bond with the insert part. The result is a leakproof bond between the insert part and the plastics component A1 or A2. Injection of the plastics molding composition here generally takes place at the pressures conventional in injection molding. However, if, for example, non-uniform injection around the insert part can cause it to deform, it is preferable that the maximum pressure at which the injection of component A1 or A2 takes place in the mold is less than 900 bar, more preferably less than 600 bar. The low injection pressure avoids deformation of the insert part when the material is injected around it. Once the material has been injected around the insert part, the first plastics component A1 or A2 hardens and becomes solid. A further advantage of injecting the first plastics component A1 or A2 around the insert part is that the insert part is stabilized by said plastics jacketing.

A very wide variety of shapes can be realized when the insert part is sheathed by the first plastics component A1 or A2. By way of example, it is possible to realize a rectangular, rhombic, pentagonal, octagonal, circular, or elliptical cross section. If the plastics jacketing composed of the first plastics component A1 or A2 has corners, these can also be rounded corners.

Junctions between the surfaces of the sheathing composed of the first plastics component A1 or A2 can be obtuse-angled, acute-angled, or rounded junctions. There can also be distinct melt lips, i.e. thin protruding regions composed of the first plastics component A1 or A2. These are then melted and deformed when the second plastics component B is injected over the material. A coherent bond is thus produced.

There can also be protruding regions designed on the material injected around the insert part and composed of the first plastics component A1 or A2. By way of example, the first plastics component A1 or A2 can enclose the insert part with a cross section in the shape of a double T. An interlock bond can be achieved via the protruding regions when the first plastics component A1 or A2 is injected around the material in this way. Since injection of the second plastics component B over the first plastics component A1 or A2 generally causes incipient melting of the latter, the shape of the material previously injected, composed of the first plastics component A1 or A2, can generally change if the processing temperature of the second plastics component B is above the melting point or the softening point of the first plastics component A1 or A2. It is also possible that the material previously injected, composed of the first plastics component A1 or A2, is deformed via the pressure of the injected melt when the second plastics component B is injected around the material. By way of example, sharp edges of the material previously injected, composed of the first plastics component A1 or A2, can be rounded.

Once the insert part has been sheathed with the first plastics component A1 or A2, the insert part thus sheathed is sheathed with the second plastics component B. The sheathing with the second plastics component B preferably likewise takes place via an injection-molding process. The injection-molding process here is generally carried out with the pressures conventional in injection molding. If the plastics molding composition has been injected with low injection pressure, the pressure in the mold here is generally higher than the maximum pressure in the mold in step (a). During injection of the second plastics component B, the surface of hardened first plastics component A1 or A2 preferably undergoes incipient melting, thus producing particularly good adhesion between the first plastics component A1 or A2 and the second plastics component B.

The sheathing of the insert part with the first plastics component A1 or A2 in step (a) and the molding of the exterior sheathing composed of the second plastics component B in step (b) can take place in the same injection mold. For this, it is necessary that the injection mold initially encloses a cavity which corresponds to the shape of the insert part with the sheathing composed of the first plastics component A1 or A2. The mold must then open in such a way that the unoccupied shape corresponds to the shape of the finished component. The person skilled in the art is aware of appropriate molds.

However, as an alternative it is also possible that the sheathing of the insert part with the first plastics component A1 or A2 in step (a) takes place in a first mold and that the molding of the exterior sheathing composed of the second plastics component B in step (b) takes place in a second mold. In that case it is necessary that the insert part sheathed with the first plastics component A1 or A2 is removed from the first mold and placed in the second mold prior to injecting of the second plastics component B around the material. If the intention is to avoid deformation of the sheathing of the insert part composed of the first plastics component A1 or A2, it is necessary that the first plastics component A1 or A2 exhibits sufficient mechanical resistance to the approaching flow of melt of the second plastics component B. This requires sufficient stiffness and strength, and these are dependent on the degree of hardening of the first plastics component A1 or A2 and on the injection pressure of the second plastics component B.

In order to avoid the necessity for cleaning of the injection-molding machine after every injection procedure, in order to change the material, it is preferable that two different injection-molding machines or plastifying units are used for the first plastics component A1 or A2 and the second plastics component B. If the sheathing in step (a) and the molding of the exterior sheathing in step (b) take place with the same mold, it is possible that the mold has simultaneous connection to both injection-molding machines. An alternative possibility is to begin by connecting the mold to the injection-molding machine which injects the first plastics component A1 or A2 and then to connect the mold to the injection-molding machine that injects the second plastics component B around the insert part with the sheathing composed of the first plastics component A1 or A2. Examples of conventional injection-molding machines used for this purpose are injection-molding machines with turntable mold. These have, by way of example, an opposite arrangement of the cylinders, and in each case the mold is rotated toward the cylinder from which the next material will be injected. If two different molds are used, each of these preferably has connection to an injection-molding machine. A suitable injection-molding machine here is any desired injection-molding machine known to the person skilled in the art.

It is possible that, in step (b), the second plastics component B sheaths only parts of the insert part sheathed with the first plastics component A1 or A2. In that case it is preferable that the regions around which the second plastics component B is injected are those having an external surface, since sheathing with the second plastics component B ensures that the molding has dimensional stability. Another possible alternative is, of course, that the second plastics component B is injected around the entire insert part with the sheathing composed of the first plastics component A1 or A2.

In that version of the process which comprises first molding the exterior sheathing composed of the second plastics component B, where regions of the insert part are not sheathed, and, in a second step, sheathing the unsheathed regions of the insert part with the first plastics component A1 or A2, the preferred method of sheathing of the insert part with the second plastics component B is that said component sheaths the insert part in those regions in which external surfaces are present. The regions onto which the first plastics component A1 or A2 is cast preferably have no outward-facing areas. This method ensures that the resultant component has geometric and dimensional stability.

The sheathing of the insert part with the second plastics component B preferably takes place via an injection-molding process. For this, the insert part is placed in an injection mold, and the second plastics component B is then injected around the same. To avoid penetration of the second plastics component B into the regions intended to be excluded, the mold is in contact with the insert part in those regions. Once the insert part has been sheathed with the second plastics component B, the regions that are intended for sheathing with the first plastics component A1 or A2 are rendered accessible. For this, it is possible either to have movable parts provided in the mold which initially form the exclusions and then render the exclusions accessible so that they can be cast by the first plastics component A1 or A2, or to remove, from the mold, the insert part around which the second plastics component B has been injected, and to place it in a second mold in which the regions intended for sheathing with the first plastics component A1 or A2 have been rendered available.

The sheathing with the first plastics component A1 or A2 preferably likewise takes place via an injection-molding process. This is generally carried out with the pressures conventional in injection-molding processes. If, for example, non-uniform injection around the insert part can cause it to deform, the injection-molding process for the first plastics component A1 or A2 is preferably carried out at a lower pressure than the injection-molding process used to inject the second plastics component B around the insert part. The pressure for the sheathing of the insert part with the first plastics component A1 or A2 is then preferably below 900 bar, with preference below 600 bar.

The preferred method of achieving a leakproof bond between the first plastics component A1 or A2 and the second plastics component B is that the melt of the first plastics component A1 or A2 causes incipient melting on the surface of the plastics component B, so that, for example, interdiffusion produces particularly good adhesion between the first plastics component A1 or A2 and the second plastics component B. A further possibility is chemical and/or mechanical bonding between the first plastics component A1 or A2 and the second plastics component B. A chemical bond can be produced, for example, via reaction of the polymer components of the first plastics component A1 or A2 and of the second plastics component B, for example by forming covalent bonds between the first plastics component A1 or A2, or one component of the first plastics component A1 or A2, and the second plastics component B, or one component of the second plastics component B. Another possibility always available is to design the process in such a way as to give not only good adhesion but also an interlock bond between the first plastics component A1 or A2 and the second plastics component B.

The melt temperature of the first plastics component A1 or A2 during the first injection of material around the insert part is preferably in the region of the usual temperature for processing of the underlying polymer by injection molding. If the first plastics component A1 or A2 is a mixture composed of two polymers, the melt temperature is selected to be sufficiently high that both components are liquid.

A higher processing temperature leads to a more free-flowing melt which can provide better wetting of the surface of the insert part, thus permitting achievement of higher bond strength between the material of the insert part and of the first plastics component A1 or A2. However, an excessive melt temperature can lead to thermal degradation of the first plastics component A1 or A2 or of one of its components A11 or A12 or A21 or A22.

When the second plastics component B is then injected over the component, the melt temperature of the second plastics component B is preferably in the region of the usual temperature for processing of the underlying polymer by injection molding. If the second plastics component B is a mixture composed of two polymers, the melt temperature is selected to be sufficiently high that both components are liquid.

A higher processing temperature leads to a more free-flowing melt which can provide better wetting and/or incipient melting of the surface of the sheathing composed of the first plastics component A1 or A2, thus permitting achievement of higher bond strength between the second plastics component B and the first plastics component A1 or A2. As a function of the thermodynamic compatibility of the two components, a boundary layer of varying thickness can arise, improving leakproof properties via interdiffusion, and providing a coherent bond between plastics components A1 or A2 and the second plastics component B. The melt temperature of the second plastics component B is preferably not set so high that the sheathing composed of the first plastics component A1 or A2 is entirely melted and ablated. It is also preferable that the injection pressure for the second plastics component B is selected in such a way that the sheathing composed of the first plastics component A1 or A2 is not excessively deformed, or, in the worst case, ablated.

The component of the invention is by way of example the type of plastics part used in electrical engineering. It is also possible that the component is a mechatronic component or a plastics casing with plug-in contacts. Components of this type are used by way of example as sensors, for example as oil sensors, wheel-rotation-rate sensors, pressure sensors, etc., as electronics casings, as control casings, for example in the ABS sector, the ESP sector, the transmission-system sector, or the airbag sector, or in the engine-control system of motor vehicles. The components can also be used by way of example as window-lifter modules or for the headlamp control system. The components of the invention can also be used outside of the automobile industry by way of example as sensors, as fill-level indicators, or as pipeline units. Examples of another suitable use of the components of the invention are electronics components in household devices. Examples of suitable components are relays, coil formers, switch parts, magnetic valves, electrical hand tools, plug devices, or plug connectors.

A feature of the component of the invention, composed of the insert part with the sheathing composed of the first plastics component A1 or A2 and the exterior sheathing composed of the second plastics component B, is that it is leakproof along both interfaces, i.e. the interface between insert part and sheathing composed of the first plastics component A1 or A2 and the interface between the first plastics component A1 or A2 and the second plastics component B. A leakproof bond here means that the leakage rate in a test under changing climatic conditions using at least 200 cycles in which the component to be tested is subjected to an alternating temperature of −40° C. and +150° C. is smaller than 0.5 cm³/min. The leakage rate is usually determined by a pressure-difference method with a test pressure of 0.5 bar.

### EXAMPLES

Test specimens are produced from an insert part composed of CuSn₆ sheathed with a first plastics component A1 or A2 and with a second plastics component B, where the first plastics components A is the above-described plastics component A1 or A2.

To produce the test specimens, a punching die is first used to punch the insert part from strips of CuSn₆. The insert part has a rectangular frame, and there is also a central fillet here connecting the opposite short sides of the frame. The length of the insert part produced is 30 mm, its width is 10.5 mm, and its height is 0.5 mm. The length of the grooves between the exterior fillets of the frame and the central fillet is 25 mm, and the width of the grooves is 3 mm.

After the punching process, the punched parts are cleaned with acetone to remove oils and impurities. An injection-molding machine with screw diameter 18 mm is used to produce the test specimens (Allrounder 270S from Arburg). The clamping force of the mold is 500 kN, and the injection pressure is 1500 bar. Material in the shape of a parallelepiped is injected around the central region of the insert part with the three fillets, whereupon the sheathing composed of the second plastics component B completely encloses the first plastics component A. The length of the sheathing composed of the first plastics component A is 15 mm, its width is 4.5 mm, and its thickness is 1.5 mm, while the length of the sheathing composed of the second plastics component B, which completely encloses the first plastics component A, is 20 mm, its width is 13 mm, and its thickness is 4.5 mm. The injection of the first plastics component A onto the insert part and the injection of the second plastics component B onto the insert part sheathed with the first plastics component A take place approximately at the mold-parting line.

In order to test the materials, the components with the sheathing composed of the first plastics component A and with the sheathing composed of the second plastics component B are subjected to temperature-shock stressing, using up to 500 cycles. The following schedule applied here for each temperature-shock cycle: 15 minutes of storage at 150° C., temperature change to −40° C. within 10 seconds, 15 minutes of storage at −40° C., temperature change to 150° C. within 10 seconds. The temperature-shock treatment took place in a VT 703052 temperature-shock cabinet from Vötsch. Leakproof properties were measured by means of a differential-pressure method prior to stressing, and also after 100, 200, and, optionally, 500 cycles.

For the differential-pressure test, two volumes are subjected to the same pressure, a test volume and a control volume. If the test volume is not leakproof, a pressure difference arises and can be directly measured. As an alternative, the pressure drop per unit of time can be measured. In the present embodiment, the exterior periphery of the test specimen was tightly clamped into a holder and pressure was applied to the underside of the test specimen. The system was sealed by a rubber sealing ring. A blind trial using a solid test specimen composed of component B1 was used to demonstrate that the only leaks that cause leakage from the test volume are those arising in the direction of the insert part, between insert part and the sheathing composed of the first plastics component A, or between the sheathing composed of the first plastics component A and the sheathing composed of the second plastics component B. The test medium used was air. The test volume Vₜₑₛₜ was 36 ml. The time required to fill the volumes with a test pressure of 0.5 bar was 5 seconds. After 10 seconds of standing time, the pressure drop was measured for Δtₜₑₛₜ=5 seconds. The volumes were then evacuated within 2 seconds. The differential pressure drop was used in the Boyle-Marriotte equation to calculate the leakage rates:

$${Q}_{leak} [ ml / min ] = \frac{{V}_{test} \cdot Δ p}{Δ {t}_{test} \cdot 1000 mbar}$$

Table 1 collates the results.

TABLE 1
Experimental results

| | | Main injection = B1 | | Main injection = B2 | |
|---|---|---|---|---|---|
| | | Leakage rate | Leakage | Leakage rate | Leakage |
| | | in freshly | rate after | in freshly | rate after |
| | Preliminary | injected state | 500 TSC | injected state | 500 TSC |
| | injection | [ml/min] | [ml/min] | [ml/min] | [ml/min] |
| Comp. 1 | A1 | 0.11 ± 0.07 | 0.8 ± 0.3 | | |
| Inv. 1 | A1 | | | 0.08 ± 005 | 0.5 ± 0.4 |
| Comp. 2 | A2 | 0.33 ± 0.09 | 0.4 ± 0.5 | | |
| Inv. 2 | A2 | | | 0.5 ± 0.1 | 0.1 ± 0.1 |
| Comp. 3 | A3 | 0.12 ± 0.06 | 0.3 ± 0.3 | | |
| Inv. 3 | A3 | | | 0.12 ± 0.07 | 0.02 ± 0.02 |
| Comp. 4 | A4 | 0.7 ± 0.7 | 0.1 ± 0.3 | | |
| Inv. 4 | A4 | | | 0.2 ± 0.1 | 0.02 ± 0.01 |

In the table, components A1to A4 stand for different overall compositions of component A.

Components B1 and B2 are different injections, with component B1 being an external jacketing in accordance with the prior art, and B2 being the component B according to the invention.

TSC denotes temperature shock cycles.

Component A1 is a copolymer of the monomers styrene (40% by weight), α-methylstyrene (30% by weight), and acrylnitrile (20% by weight), comprising a butadiene phase (10% by weight), having a modulus of elasticity of 2400 MPa and a Vicat softening temperature of 115° C.

Component A2 is a blend of 90% by weight of component A1 and 10% by weight of a random copolyester of terephthalic acid (25 mol %), 1,4-butanediol (50 mol %), and adipic acid (25 mol %), with a melting point of 110 to 120° C. (measured by DSC to ISO 11357-3) and a Shore D hardness of 32, determined to ISO 868. The Vicat softening temperature is 91° C., measured to EN ISO 306: 2004.

Component A3 is a mixture of 97% by weight of component A1 and 3% by weight of an epoxy-functionalized styrene-acrylic acid copolymer with a molecular weight M_{w} of 6800 g/mol and a degree of functionalization of more than 4 epoxy groups per molecule chain. The glass transition is situated at 54° C.

Component A4 is a blend composed of 45% by weight of a random aliphatic-aromatic copolyester produced from terephthalic acid (25 mol %), adipic acid (25 mol %), and butanediol (45 mol %), with 45% by weight of polylactide (PLA), Said blend has two melting points, of 110 to 120° C. and 140 to 155° C., as determined by means of DSC, a Vicat softening temperature (VST A 50) of 68° C., measured to ISO 306: 2004, a Shore D hardness of 59, measured to ISO 868, and a modulus of elasticity of 750 MPa, determined to ISO 527 on blown films of 50 μm in thickness.

Component B1 is a polybutylene terephthalate with 30% by weight of glass fibers, with a viscosity number of 102 g/ml, measured in 0.5% solution in phenol/o-dichlorobenzene (1:1) to ISO 1628. It also comprises 0.1% by weight of a furnace black with average particle size of between 10 and 35 nm (CILAS) and with a BET surface area of 110-120 m²/g (ISO 9277), plus 0.5% by weight of pentaerythritol tetrastearate as lubricant. The material has a modulus of elasticity of 10 000 MPa (ISO 527-2) and a melting range of 220-225° C. (measured by DSC to ISO 11357-3). The diameter of the glass fibers is 10 μm.

Component B2 is a mixture comprising 99.5% by weight of component B1 and 0.5% by weight of a hyperbranched polycarbonate. The hyperbranched polycarbonate was prepared by forming an equimolar mixture of trimethylpropane×3 ethylene oxide, as polyfunctional alcohol, with diethyl carbonate, in a three-neck flask equipped with stirrer, reflux condenser, and internal thermometer, and adding 250 ppm of K₂CO₃ (based on the amount of alcohol) as catalyst. The mixture was then heated to 100° C. with stirring and stirred at that temperature for 2 h. As the period of reaction progressed, there was a reduction in the temperature of the reaction mixture, owing to the onset of evaporative cooling of the monoalcohol released. The reflux condenser was then switched for a descending condenser, ethanol was distilled off, and the temperature of the reaction mixture was slowly raised to 160° C.

The ethanol removed by distillation was collected in a chilled, round-bottom flask and weighed, and hence the conversion was determined as a percentage in relation to the full conversion theoretically possible. The amount of ethanol in the distillate, relative to full conversion, is 90 mol %.

The reaction products were subsequently analyzed by gel permeation chromatography, using dimethylacetamide as eluent and polymethyl methacrylate (PMMA) as standard.

The hyperbranched polycarbonate has a number-average molecular weight Mₙ of 2500 g/mol and a weight-average molecular weight M_{w} of 4100 g/mol. The viscosity at 23° C. is 4020 mPas and the OH number according to DIN 53240, Part 2, is 310 mg KOH/g.

From the examples with exterior injection of component B as per the prior art, and with an exterior component B as per the present invention, it can be seen that better sealing, i.e., a lower leakage rate, following temperature treatment is always measured, by comparison with an exterior injection component containing no highly branched or hyperbranched polycarbonate and/or highly branched or hyperbranched polyester.

Even in the freshly injected component, i.e. without the temperature treatment having been carried out, the leakage rates measured for the inventive component B as main injection were likewise the same or lower—with the exception of the combination A2 and B.

1.-13. (canceled)

14. A component comprising an insert part and plastics jacketing composed of at least two plastics components, wherein the insert part is enclosed by a first plastics component A1, wherein the first plastics component A1 is composed of:
A11: from 5 to 80% by weight, based on the total weight of components A11 and A12, of at least one semiaromatic polyester based on aliphatic and aromatic dicarboxylic acids and on aliphatic dihydroxy compounds;
A12: 20 to 95% by weight, based on the total weight of components A11 and A12, of at least one homo- or copolyester selected from the group consisting of polylactide (PLA), polycaprolactone, polyhydroxyalkanoate, and polyester derived from aliphatic dicarboxylic acids and aliphatic diols;
A13: 0.05 to 15% by weight, based on the total weight of components A11 and A12,
a) of a copolymer which contains epoxy groups and which is based on styrene, on acrylate, and/or on methacrylate, b) of a bisphenol A epoxide, or c) of a fatty acid amide, fatty acid ester, or natural oil containing epoxy groups,
or by a first plastics component A2, the first plastics component A2 being composed of:
A21: 10 to 100% by weight, based on the total weight of components A21 and A22, of at least one thermoplastics styrene(co)polymer,
A22: 0 to 90% by weight, based on the total weight of components A21 and A22, of at least one thermoplastic(co)polyester,
A23: 0.05 to 15% by weight, based on the total weight of components A21 and A22,
a) of a copolymer which contains epoxy groups and which is based on styrene on acrylate, and/or on methacrylate, b) of a bisphenol A epoxide, or c) of a fatty acid amide, fatty acid ester, or natural oil containing epoxy groups,
and the first plastics component A1 or the first plastics component A2 is enclosed by a second plastics component B, and the second plastics component B is composed of
B1: 10 to 99.99% by weight of at least one thermoplastic polyester,
B2: 0:01 to 50% by weight of
B21: at least one highly branched or hyperbranched polycarbonate having an OH number of 1 to 600 mg KOH/g polycarbonate (as per DIN 53249, Part 5 2)
or
B22: at least one highly branched or hyperbranched polyester of the type AₓB_{y} where x is at least 1.1 and y is at least 2.1,
or mixtures thereof,
it being further possible for the first plastics component A1 or the first plastics component A2 and/or the second plastics component B to comprise:
C 0 to 60% by weight of at least one further adjuvant.

15. The component according to claim 14, wherein the plastics component B further comprises 1 to 40% by weight of an impact-modified polymer D.

16. The component according to claim 14, wherein the plastics component B further comprises 1 to 60% by weight of at least one graft polymer E composed of
E1: 20 to 80% by weight of a graft base comprising a rubber-elastic polymer based on alkyl acrylates having 1 to 8 C atoms in the alkyl radical and having a glass transition temperature of below 10° C.
E2: 20 to 80% by weight of a graft composed of
E21: 60 to 95% by weight of styrene or substituted styrenes of the general formula (I) 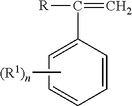
in which R is an alkyl radical having 1 to 8 C atoms or is a hydrogen atom and R¹ is an alkyl radical having 1 to 8 C atoms, and n has a value of 1, 2 or 3, and
E22: 5 to 40% by weight of at least one unsaturated nitrile
and
F: 0 to 60% by weight of a copolymer of
F1: 60 to 95% by weight of styrene or substituted styrenes of the general formula (I) or mixtures thereof
F2: 5 to 40% by weight of at least one unsaturated nitrile.

17. The component according to claim 14, wherein the plastics component B further comprises 1 to 30% by weight, based on the total mass of the plastics component B, of a flame retardant combination G composed of
G1: 20 to 99% by weight of a halogen-containing flame retardant, and
G2: 1 to 80% by weight of an antimony oxide.

18. The component according to claim 14, wherein the plastics component B further comprises 1 to 40% by weight of a halogen-free flame retardant H which is a phosphorus-containing compound, nitrogen-containing compound or of P/N condensate or mixtures thereof.

19. The component according to claim 14, wherein the at least one further adjuvant C is selected from the group consisting of a processing aid, a stabilizer, an oxidation retardant, an agent to counter thermal decomposition and decomposition due to ultraviolet light, a lubricant and mold-release agent, a colorant, a nucleating agent, a plasticizer, and a fibrous or particulate filler.

20. The component according to claim 19, wherein the particulate filler is selected from group consisting of carbon fiber, glass fiber, glass bead, amorphous silica, asbestos, calcium silicate, calcium metasilicate, magnesium carbonate, kaolin, chalk, powdered quartz, mica, barium sulfate, feldspar, and mixtures of two or more of these substances.

21. The component according to claim 14, wherein the first plastics component A comprises 0.1 to 40% by weight of glass beads, based on the total mass of the first plastics component A.

22. The component according to claim 14, wherein the second plastics component B comprises 0.1 to 50% by weight of fibrous fillers, based on the total mass of the second plastics component B.

23. The component according to claim 14, wherein the second plastics component B comprises 0.1 to 50% by weight of glass fibers, based on the total mass of the second plastics component B.

24. The component according to claim 14, wherein the insert part has been manufactured from copper, from a copper-containing alloy, from aluminum, from an aluminum-containing alloy, from titanium, from stainless steel, from a lead-free metal or metal alloy, or from any material with tin coating.

25. The component according to claim 14, wherein the component is a plastics part as used in electronic engineering, a mechatronic component, or a plastics casing with plug-in contacts.

26. A process for the production of a component comprising an insert part and plastics jacketing composed of at least two plastics components, said process comprising the following steps;
(a) sheathing of an insert part with a first plastics component A1, where the first plastics component A1 is composed of:
A11: from 5 to 80% by weight, based on the total weight of components A11 and A12, of at least one polyester based on aliphatic and aromatic dicarboxylic acids and on aliphatic dihydroxy compounds;
A12: 20 to 95% by weight, based on the total weight of components A11 and A12, of at least one homo- or copolyester selected from the group consisting of polylactide (PLA), polycaprolactone, polyhydroxyalkanoates, and polyester derived from aliphatic dicarboxylic acids and aliphatic diols;
A13: 0.05 to 15% by weight, based on the total weight of components A11 and A12, a)of a copolymer which contains epoxy groups and which is based on styrene, on acrylate, and/or on methacrylate, b) of a bisphenol A epoxide, or c) of a fatty acid amide, fatty acid ester, or natural oil containing epoxy groups,
or with a first plastics component A2, where the first plastics component A2 is composed of:
A21: 10 to 100% by weight, based on the total weight of components A21 and A22, of at least one thermoplastics styrene(co)polymer,
A22: 0 to 90% by weight, based on the total weight of components A21 and A22, of at least one thermoplastic(co)polyester,
A23: 0.05 to 15% by weight, based on the total weight of components A21 and A22, a) of a copolymer which contains epoxy groups and which is based on styrene on acrylate, and/or on methacrylate, b) of a bisphenol A epoxide, or c) of a fattyacid amide, fatty acid ester, or natural oil containing epoxy groups,
(b) molding of exterior sheathing composed of a second plastics component 8, where the second plastics component B is composed of:
B1: 10 to 99.99% by weight of at least one thermoplastic polyester,
B2: 0.01 to 50% by weight of
B21: at least one highly branched or hyperbranched polycarbonate having an OH number of 1 to 600 mg KOH/g polycarbonate (as per DIN 53249, Part 2)
or
B22: at least one highly branched or hyperbranched polyester of the type AₓB_{y} where x is at least 1.1 and y is at least 2.1,
or mixtures thereof,
it being further possible for the first plastics component A1 or the first plastics component A2 and/or the second plastics component B to comprise:
C 0 to 60% by weight of at least one further adjuvant,
and where either the insert part is first sheathed with the first plastics component A1 or A2 and then the second plastics component B is applied, or the exterior sheathing B is first molded, and then the first plastics component A1 or A2 is charged to a cavity formed between the exterior sheathing, composed of the second plastics component B, and the insert part, in order to form the sheathing of the insert part.

27. The process according to claim 26, wherein the sheathing of the insert part with the first plastics component A and the sheathing composed of the second plastics component B are produced via an injection-molding process.
